(19) United States
(12) Patent Application Publication
(10) Pub. No.: US 2014/0215176 A1
(43) Pub. Date: Jul. 31, 2014

(54) MEMORY ALLOCATION CONTROL METHOD, RECORDING MEDIUM, AND INFORMATION PROCESSING DEVICE

(71) Applicant: FUJITSU LIMITED, Kawasaki-shi (JP)

(72) Inventor: Yoshihiro IGA, Kawasaki (JP)

(73) Assignee: FUJITSU LIMITED, Kawasaki-shi (JP)

(21) Appl. No.: 14/230,497

(22) Filed: Mar. 31, 2014

Related U.S. Application Data
(63) Continuation of application No. PCT/JP2011/073230, filed on Oct. 7, 2011.

(51) Int. Cl. G06F 12/02

(52) U.S. Cl. CPC G06F 12/0223
USPC 711/170

(57) ABSTRACT

A method executed by a processor in a computer including the processor and memory includes: trying to allocate a block of the memory by the processor at a request for memory allocation, in a first case in which a result of a judgment on a probability of success or failure of the memory allocation based on a time taken for the processor to perform each of one or more specific procedures indicates that there is a high probability that the memory allocation succeeds; and either trying to allocate the block of the memory by the processor with a delay with respect to the first case, or returning by the processor, without trying to allocate the block of the memory, a reply that the memory allocation has failed, in a second case in which the result of the judgment indicates that there is a high probability that the memory allocation fails.

### CROSS-REFERENCE TO RELATED APPLICATION

This application is a continuation application of International Application PCT/JP2011/073230 filed on Oct. 7, 2011 and designated the U.S., the entire contents of which are incorporated herein by reference.

### FIELD

The embodiments discussed herein are related to a technology of memory allocation.

### BACKGROUND

The allocation of memory blocks in a computer implies some study themes. For example, a memory leak occurs unless dynamically allocated memory is released (i.e., freed). Therefore, the technology relating to the protection against or the monitor of a memory leak has been developed. For example, when a computer system is continuously used, the following technique has been proposed to avoid a deadlock of the computer due to a memory leak etc.

An information acquiring unit in a computer system periodically acquires an amount of memory usage and a load of a CPU (central processing unit) from an OS (operating system) management table. Then, the information acquiring unit stores the acquired memory usage and CPU load with an acquisition time in a memory load history information area and a CPU load history information area.

Furthermore, when an information analyzing unit detects an occurrence of a memory leak from memory load history information, it predicts a reach time at which the memory usage reaches a threshold of a memory use limit. Furthermore, the information analyzing unit predicts a time period in which a load is low immediately before the reach time above, and sets a recovery procedure execution unit so that a recovery procedure may be performed in a predicted time period.

Another study theme is a method of allocating a block of memory to efficiently use finite memory resources. For example, a configuration for performing an imaging procedure by executing in parallel a plurality of threads corresponding to an imaging procedure module connected by a pipeline mode etc. is considered as an example of a configuration for executing an imaging procedure. With the configuration, the following method is proposed to continue the entire imaging procedure although memory resources become temporarily short.

The method includes judging whether or not a requested memory area may be reserved each time a request to acquire memory from a thread corresponding to each module is received. The method also includes allocating a memory area if the memory area may be reserved. The method further includes stopping an operation of a requester thread and registering acquisition request information in a queue unless the requested memory area may be reserved.

This method also includes releasing a requested memory area when a memory release is requested by any thread. The method further includes performing the following sequential processes in order from the acquisition request information retrieved at the head of the queue. Concretely, the sequential processes refer to judging whether or not the memory area requested by the acquisition request information in the queue may be reserved, retrieving the acquisition request information from the queue is the memory area may be reserved, releasing the operation stop state of a thread, and allocating a memory area.

Some documents including Japanese Laid-open Patent Publication No. 2004-5305, Japanese Laid-open Patent Publication No. 2007-323393, etc. are known relating to the technology above.

### SUMMARY

According to an aspect of the embodiments, a memory allocation control method executed by a processor in a computer including the processor and memory is provided. The memory allocation control method includes: trying to allocate a block of the memory by the processor at a request for memory allocation, in a first case in which a result of a judgment on a probability of success or failure of the memory allocation based on a time taken for the processor to perform each of one or more specific procedures indicates that there is a high probability that the memory allocation succeeds; and either trying to allocate the block of the memory by the processor with a delay with respect to the first case, or returning by the processor, without trying to allocate the block of the memory, a reply that the memory allocation has failed, in a second case in which the result of the judgment indicates that there is a high probability that the memory allocation fails.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates flowcharts of two examples of a memory allocation control method according to the first embodiment;

FIG. 2 is a block diagram of a computer according to the first embodiment;

FIG. 3 is a hardware configuration diagram of a computer common among the first through third embodiments;

FIG. 4 is a block diagram of a computer common between the second and third embodiments;

FIG. 5 is an explanatory view of a memory allocation control method according to the second embodiment;

FIG. 6 illustrates data used in the second embodiment;

FIG. 7 is a flowchart of a system test common between the second and third embodiments;

FIG. 8 is a flowchart of a procedure of acquiring information in a low load state according to the second embodiment;

FIG. 9 is a flowchart of a test execution procedure common between the second and third embodiments;

FIGS. 10A and 10B illustrate a flowchart of a memory acquisition procedure according to the second embodiment;

FIG. 11 illustrates data used in the third embodiment;

FIG. 12 is a flowchart of a procedure of acquiring information in a low load state according to the third embodiment;

FIGS. 13A and 13B illustrate a flowchart of a memory acquisition procedure according to the third embodiment.

### DESCRIPTION OF EMBODIMENTS

It is preferable that a computer efficiently works. However, in a certain condition, the efficiency of a computer may be reduced by a procedure of trying memory allocation at a request for the memory allocation.

An aspect of the following embodiment aims at appropriately controlling the memory allocation in such a way as to suppress the degradation in the efficiency of a computer. According to the following embodiments, the degradation in the efficiency of a computer caused by execution of a procedure of trying to allocate a block of memory is avoidable.

The embodiments are described below in detail. Concretely, the common purpose among the first through third embodiments is described below. Then, the first through third embodiments are described in detail with reference to the drawings.

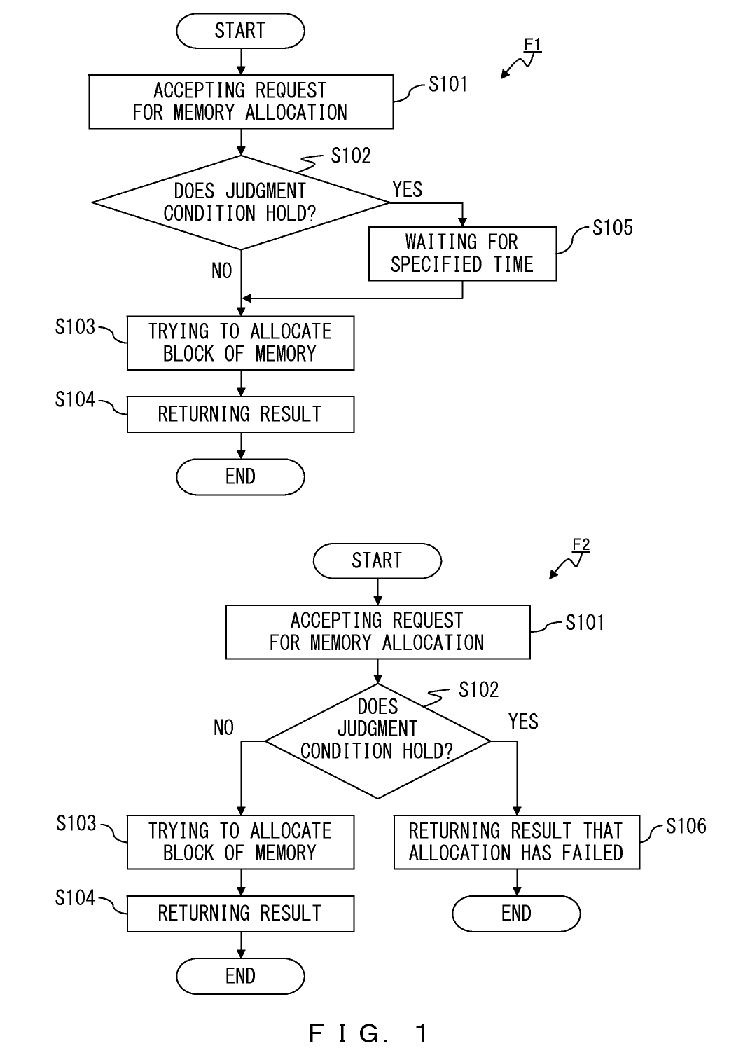

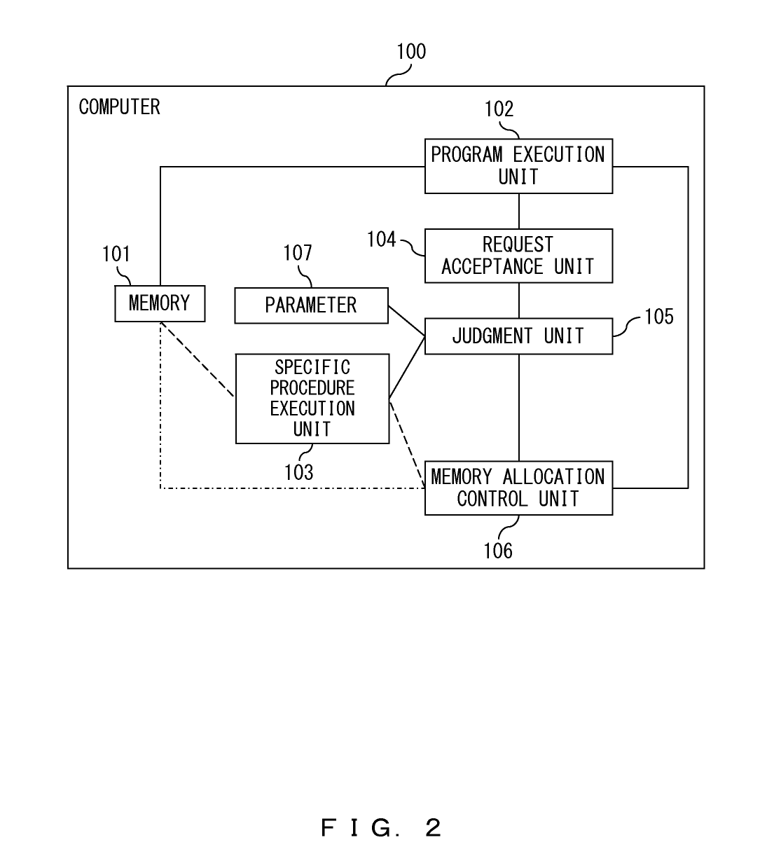

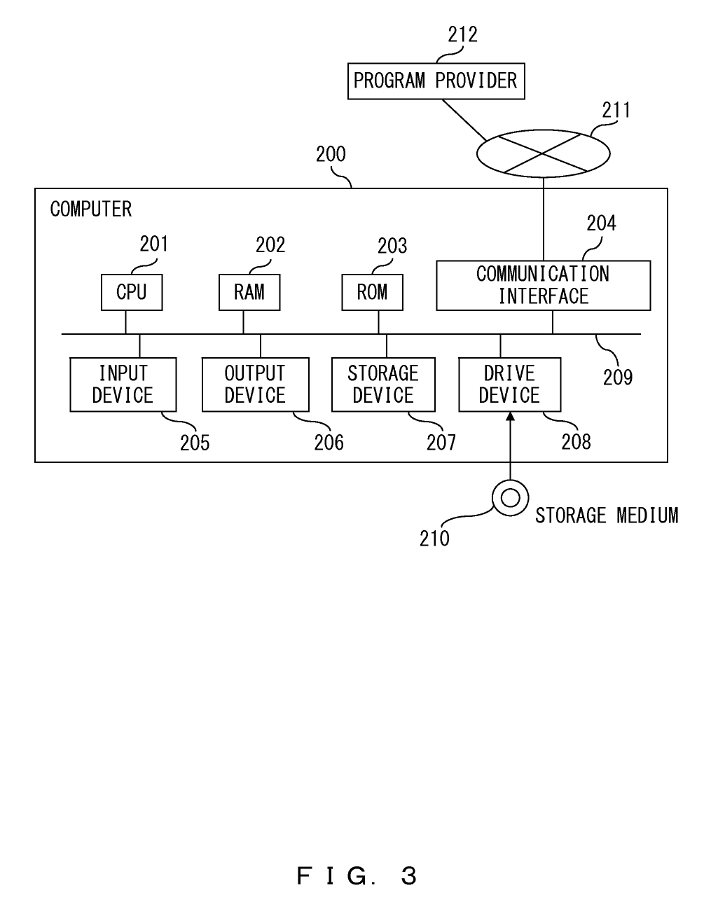

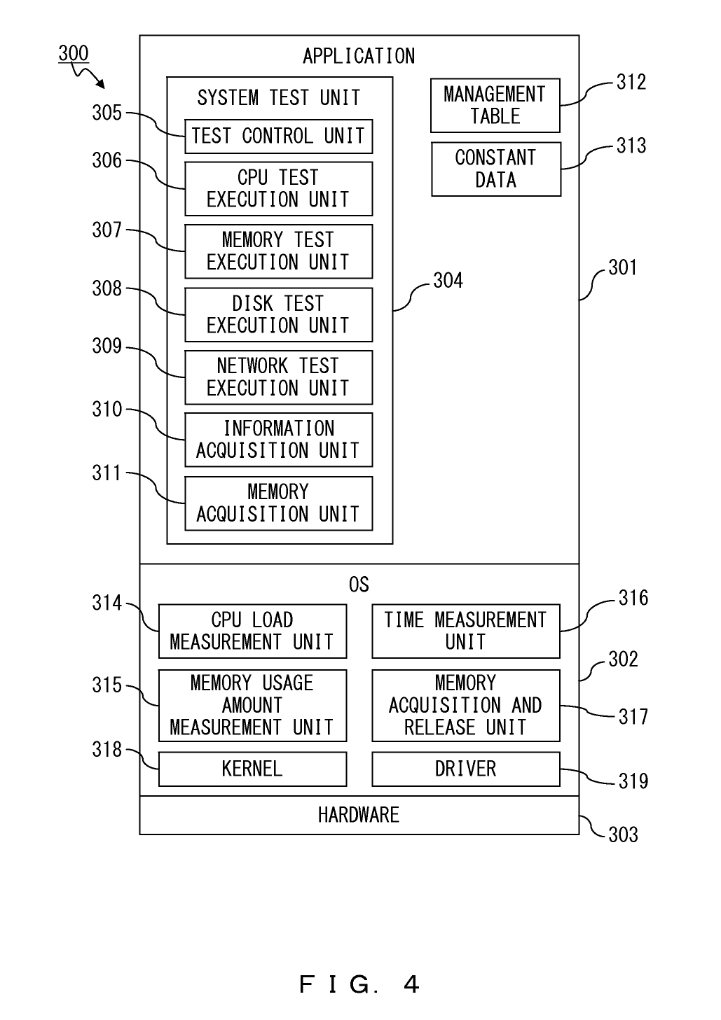

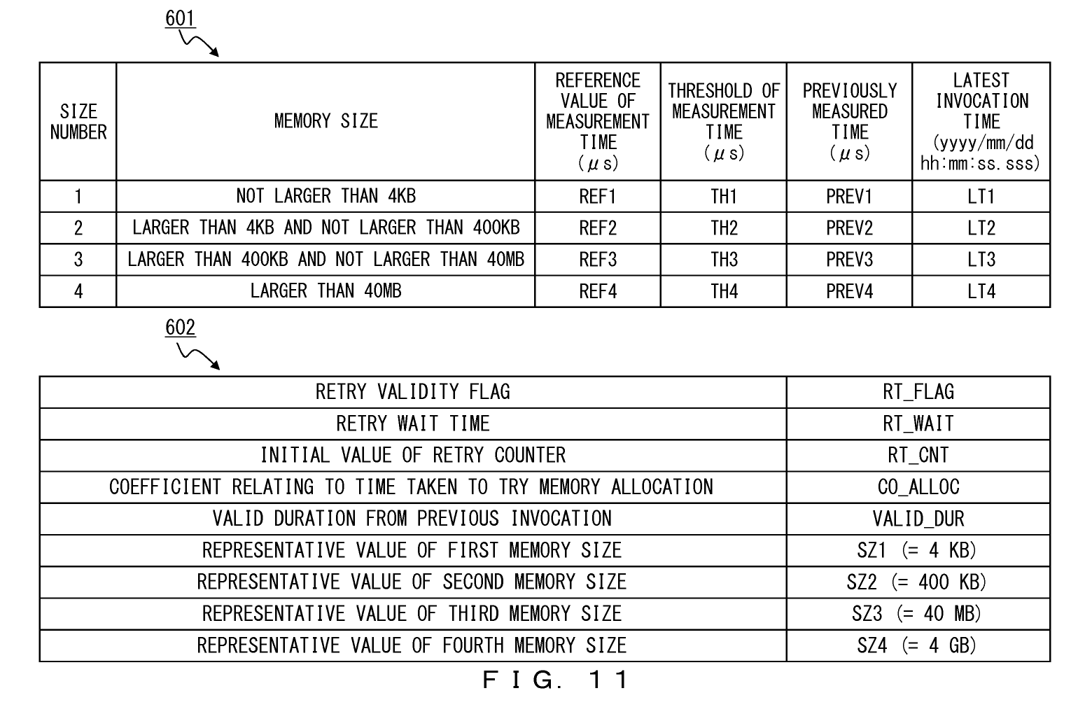

Concretely, the first embodiment is described with reference to FIGS. 1 and 2. Next, the hardware configuration of a computer common among the first through third embodiments is described with reference to FIG. 3. Then, the second embodiment is described with reference to FIGS. 4 through 10B. In FIGS. 4 through 10B, FIGS. 4, 7, and 9 indicate common points between the second and third embodiments. Furthermore, the third embodiment is described with reference to FIGS. 11 through 13B. Finally, other variation examples are described.

As described above, in a certain condition, the efficiency of a computer may be reduced by a procedure of trying memory allocation at a request for the memory allocation. In some cases, not only the efficiency is reduced, but also a computer may be stalled or hung. Then, the first through third embodiments aim at appropriately controlling memory allocation to avoid reduced efficiency, a stall, a hang, etc.

Concrete examples of the above-mentioned “certain condition” are described below. Described also is a reason why the procedure of trying memory allocation in the certain condition may reduce the efficiency of a computer.

The above-mentioned “certain condition” is a condition that indicates a strong likelihood that the memory allocation will fail. That is, the condition indicates a heavy load on the computer. The specific manner in which the condition is presented may depend on each embodiment.

If a computer tries memory allocation under a condition in which the load applied to the computer is so heavy that a failure in memory allocation is expected with a high probability, there is the possibility of reduced efficiency of the computer. In some cases, not only the efficiency may be reduced, but also the computer may be stalled or hung for the following reason.

When an application requests memory allocation, a library function for the memory allocation such as malloc( ) etc. or a system call for the memory allocation such as mmap( ) etc. is invoked by the application. Internally in the library function for memory allocation, a system call for the memory allocation is invoked.

Then, regardless of whether the memory allocation is requested through a library function or whether a system call is directly invoked by an application, processor resources such as CPU resources etc. are consumed for the memory allocation because the memory allocation includes some procedures such as a procedure of searching for an allocatable memory area etc.

In some cases, not only the CPU, but also other hardware resources, such as an MMU (memory management unit) for managing the relationship between a virtual address and a physical address, may also be consumed. If resources are further consumed in addition to a heavy load, then reduced efficiency, a stall, a hang, etc. may be incurred.

For example, the CPU time may be hardly allocated (i.e., assigned) to a user process as a result of a situation in which the majority of the CPU time is assigned to a kernel process for memory allocation. As a result, the progress of the user process may be disturbed and thereby its efficiency may be reduced, or a poor response may be incurred.

When a load is heavy due to a large volume of memory usage, the requested amount of memory is not always available. As a result, it may be unable to find an allocatable memory area, and therefore the memory allocation may fail. Otherwise, it may take a long time to find an allocatable memory area. As a result, the entire efficiency of the system may be degraded.

On the other hand, there is a system into which retry control is incorporated to try again memory allocation when memory allocation fails. As a result of the retry control, there is the possibility that the retry is wasted. That is, there is the possibility that each retry of memory allocation fails only to waste resources because the retry of the memory allocation is repeated although there is a strong likelihood of the failure of the memory allocation. If the processor resources are further consumed for the retry, the efficiency may be further degraded, or the computer may be stalled or hung.

A certain OS is implemented with a function referred to as an “OOM killer (out of memory killer)”. If memory allocation is requested when the OS having the OOM killer function is short of memory, the OS may send a “SIGTERM” signal or a “SIGKILL” signal to a certain process, and thereby forcibly abort the process.

That is, when a load is heavy because of a large memory usage, the procedure of trying memory allocation may forcibly abort a process being executed. If the OS inappropriately selects a process to be forcibly aborted, there is a possibility that the computer is stalled or hung.

As described above, the procedure of trying memory allocation when the load of a computer is heavy may cause various problems of reduced efficiency, stall, hang, etc. Especially when a request for the allocation of a relatively large volume of memory is made, there is a possibility that problems of reduced efficiency, stall, hang, etc. occur as compared with the case in which a request for the allocation of a small volume of memory is made.

For example, the page size defined by a certain OS is 4 KB (kilobytes). When a request to allocate a relatively large volume of memory exceeding page size is made, problems occur more easily than when a request to allocate a relatively small volume of memory of, for example, several tens through hundreds bytes, is made.

For example, applications such as a photo-retouch application, a moving picture editing application, etc. use a large volume of memory. Therefore, these applications may incur problems of reduced efficiency etc. caused by a procedure of trying memory allocation.

The performance of various computer products such as a server etc. is tested in an appropriate period during the development of a product, after putting a product to the market, etc. For example, a system test program for various tests may be executed to evaluate the performance of a server.

Since a system test is conducted to test the performance of a computer, a relatively heavy load is imposed on the computer by executing a system test program. In a certain test, a request to allocate a relatively large volume is made.

Therefore, during a test of a system, a request to allocate a relatively large volume of memory may be frequently made with a heavy load. However, for the above-mentioned reason, the problems of reduced efficiency, stall, hang, etc. may be incurred by the procedure of trying memory allocation with a heavy load. When the problems occur, the performance of a computer is not tested efficiently.

As described above, any problems may occur during memory allocation. It is difficult to avoid the problems, which may occur in the procedure of trying memory allocation, by the technology of avoiding or monitoring a memory leak. Furthermore, these problems occur not only with a specific application such as an imaging procedure application, but also with an arbitrary application.

A memory pool may be used for efficiency in dynamic memory allocation, but the problems above are not solved only by using a memory pool because processor resources are consumed as a request for memory allocation even when a memory pool is used.

Furthermore, it is difficult to solve the problems of reduced efficiency, stall, hang, etc. which may be caused by a procedure of trying memory allocation only by a method for mainly preventing exhaustion of memory resources.

For example, the following methods 1-1 through 1-3 are proposed as a countermeasure against the exhaustion of memory resources. However, in the methods 1-1 through 1-3, although the exhaustion of memory resources may be prevented to a certain extent, the problems above are not completely solved.

(1-1) A method for adjusting the amount of memory used by an application to a memory capacity of a system

(1-2) A method for providing memory in a system in advance according to the amount of memory to be used by an application

(1-3) A method for dynamically managing the capacity of the memory available for each of a plurality of applications by sharing information among the applications

For example, the method 1-1 may be more concretely a method for restricting the concurrent execution of a plurality of applications when memory is short. Otherwise, the method 1-1 may be concretely a method for adjusting a parameter of an application. For example, when an application is concretely a system test program, the memory capacity used in a system test may be adjusted by appropriately tuning each parameter for a test.

In addition, the method 1-2 may concretely be recognized by, for example, adding a memory module. The methods 1-1 and 1-2 are examples of a method for avoiding the exhaustion of memory resources.

However, the capacity of the memory to be used by an application may be uncertain in advance. For example, the capacity of the memory to be used by an application may largely vary each time an application is executed. Furthermore, the number of simultaneously executed applications may largely vary in some cases. In addition, there are some applications having no parameters for adjustment of the capacity of available memory.

Then, the method 1-3 is proposed. For example, a memory area accessible from a plurality of applications or a shared file accessible from a plurality of applications may be used for management of the method 1-3. Then, the capacity of the memory available for the entire computer, and the capacity of the memory currently available by each application may be recorded in the above-mentioned common memory area or shared file. Then, the capacity of newly allocatable memory may be calculated.

Then, each application appropriately adjusts the capacity of the memory requested by each application by referring to the common memory area or shared file. Each application updates the common memory area or the shared file depending on the acquisition and release of the memory.

However, the methods 1-1 through 1-3 have the following drawback. Therefore, it is hard in the methods 1-1 through 1-3 to avoid the problems of reduced efficiency, stall, hang, etc. caused by the procedure of trying memory allocation.

For example, in the methods 1-1 through 1-3, it is hard to consider the capacity of a memory area temporarily used by the OS for an I/O (input/output) procedure and paging. As a result, the memory allocation may fail.

For example, during the procedure of an I/O to a disk device, the OS may use memory as a buffer area (that is, cache) in order to shorten the latency for an application. The memory area temporarily used as a buffer area is released (i.e., freed), for example, after data is actually written to the disk device, and becomes available from an application. However, there may be a case in which a large volume of memory is incidentally used as a buffer area for disk I/O when an application requests memory allocation. That is, when memory allocation is requested, there may be a case in which a computer is temporarily and incidentally in the state in which a requested size of memory is not available for allocation.

Furthermore, if a newly allocatable memory area is not found on a page that exists in a physical memory, some OSs may return an error. That is, in this case, the requested memory allocation fails. Otherwise, some OSs may perform a page-in procedure and then allocate a requested size of area on the page that is read into the physical memory by the page-in procedure. In this case, it takes a long time to perform memory allocation.

Furthermore, depending on the implementation of the memory management of the OS, it may take some time from a point in time at which the memory area which has been used up to the current time is released (i.e., freed) to a point in time at which this memory area is “collected” by the OS as an available memory area for an application (that is, as a newly allocatable memory area). That is, there may be temporarily an unallocatable memory area which is not practically used by any process.

It is difficult for the methods 1-1 through 1-3 described above to consider the above-exemplified types of a temporary change of a situation which may occur relating to the memory management of the OS. This is because the methods 1-1 and 1-2 are based on the known information (for example, the physical capacity of memory of a computer, the known value of a parameter, etc.), and the method 1-3 is based on the information which may be recognized by individual applications. That is, in the method 1-3, the information which is not managed by an application itself (that is, the state of the memory management within the OS) is not considered.

Furthermore, the method 1-3 has the drawback of an additional cost for sharing resources and the drawback that the accuracy of the information shared for memory management among applications may be reduced in some cases.

For example, in the method 1-3, a common memory area or a shared file which is accessible from a plurality of applications may be used. However, to use shared resources such as a common memory area or a shared file, exclusive control about the shared resources is required. Concretely, exclusive control among processes and exclusive control among threads are required.

Furthermore, in some cases, an application may abnormally terminate before releasing dynamically acquired memory. Then, in the method 1-3, the accuracy of the information recorded in a common memory area or a shared file is degraded because, in the method 1-3, the shared information is updated by each application.

Although a memory leak caused by abnormal termination of an application may be detected by the OS and the OS may recover an available state of a detected memory area, the accuracy of shared information may be degraded in the method 1-3 because the information in a common memory area or a shared file is not updated by the OS, but is updated by each application.

Therefore, although a memory leak is detected by the OS and the memory is practically restored to an available state, the information about the capacity of the memory used by the application which has abnormally terminated is not updated. As a result, the accuracy of the information shared among the applications is degraded, and other applications request memory allocation according to incorrect information.

Then, as understood from the above-mentioned exemplification, the load of a processor such as a CPU etc. is not considered in the memory allocation in the methods 1-1 through 1-3. Furthermore, in the method 1-3, an additional load is applied to the CPU for exclusive control on the shared information. Furthermore, as described above, it is difficult in the methods 1-1 through 1-3 to consider the change in temporary state which occurs in the memory management of the OS.

Therefore, in the methods 1-1 through 1-3 which is mainly to prevent the exhaustion of memory resources, the problems of reduced efficiency, stall, hang, etc. caused by the procedure of trying memory allocation are not avoided. Therefore, the following first through third embodiments aims at preventing the problems of reduced efficiency, stall, hang, etc. caused by the procedure of trying memory allocation. That is, the first through third embodiments aims at appropriately controlling memory allocation to suppress the problems of reduced efficiency, stall, hang, etc.

Then, the first embodiment is described below with reference to FIGS. 1 and 2.

FIG. 1 is a flowchart of two examples of a memory allocation control methods according to the first embodiment. The two flowcharts F1 and F2 illustrated in FIG. 1 are examples of a memory allocation control method used by a processor in a computer having memory and a processor. The processor operates as illustrated by the flowchart F1 or F2 by executing a program.

The memory may be, for example, DRAM (dynamic random access memory). The processor may be, for example, each CPU in the computer having one or more CPUs.

Relating to FIG. 1, the procedure according to the flowchart F1 is first explained, and the procedure according to the flowchart F2 is next explained mainly on the difference from the flowchart F1. Then, the details of the flowcharts F1 and F2 are additionally described.

In step S101, the processor accepts a request for memory allocation. Then, in the next step S102, the processor judges whether or not a certain judgment condition holds. The judgment condition is, in other words, a criterion.

The judgment condition is appropriately defined in advance so that the judgment condition may hold when the likelihood of the failure of memory allocation is high (that is, so that the judgment condition may hold when the load of a computer is heavy). Concretely, the judgment condition is a condition which relates to a time taken for a processor to perform each of one or more specific procedures. More specifically, the “time” here is not the CPU time, but is a wall-clock time.

That is, in step S102, a result of a judgment on the probability of success or failure of the memory allocation is acquired. As described above, the result of the judgment is based on the time taken for a processor to perform each of one or more specific procedures. When the judgment condition is true, the result of the judgment indicates that there is a high probability that the memory allocation will fail. On the other hand, when the judgment condition is false, the result of the judgment indicates that there is a high probability that the memory allocation will succeed.

The heavier the load of a computer, the longer the time taken for a processor to perform a specific procedure. Therefore, the condition on the time taken for a processor to perform each of one or more specific procedures is available as a judgment condition for judgment of the level of the likelihood of a failure in memory allocation. Amore concrete example of a judgment condition is described later.

If a judgment condition does not hold, control is passed to step S103. That is, when the result of the judgment indicates that there is a high probability that the memory allocation will succeed, control is passed to step S103.

On the other hand, when the judgment condition holds, control is passed to step S105. That is, when the result of the judgment indicates that there is a high probability that the memory allocation will fail, control is passed to step S105.

In step S103, the processor tries to allocate a block of the memory (i.e., tries memory allocation) at a request for the memory allocation accepted in step S101. Then, in the next step S104, the processor returns a result of the trial of the memory allocation in step S103, thereby terminating the procedure of the flowchart F1.

On the other hand, in step S105, the processor waits for a specified time (i.e., a determined time). When a specified time elapses, control is passed to step S103. That is, step S105 is an example of control for trying to allocate the block of the memory with a delay with respect to a trial of memory allocation to be executed when the probability of success in the memory allocation is high. The delay time for the control is the above-mentioned “specified time”.

In the flowcharts F1 and F2 in FIG. 1, steps S101 through 104 are common. The difference is the operation performed when the judgment condition holds. If the judgment condition holds in the procedure of the flowchart F2, control is passed from step S102 to step S106.

In step S106, the processor returns a result of the failure in allocation in response to the request for memory allocation. That is, in step S106, the processor returns a reply that the memory allocation has failed, without trying to allocate the block of the memory.

By any of the memory allocation control methods indicated by the flowcharts F1 and F2 above, the problems of reduced efficiency, stall, hang, etc. which may be caused by the procedure of trying memory allocation is avoidable if the judgment condition is appropriately defined. This is because it is not the case that the memory allocation is always tried immediately regardless of the condition under which the memory allocation is requested. That is, the trial of the memory allocation is appropriately postponed or avoided depending on the situation.

According to the flowchart F1, when the judgment condition holds, the memory allocation is not immediately tried after a request for the memory allocation is made, but the memory allocation is tried after a lapse of the specified time. For example, before the lapse of the specified time, the buffer area temporarily used by the OS for the disk I/O may be released (i.e., freed) and become available. Therefore, by postponing the trial of the memory allocation, the likelihood of the success in the memory allocation may be enhanced.

Furthermore, according to the flowchart F2, when a judgment condition holds, the memory allocation is not tried even though the memory allocation is requested, and instead, a result indicating a failure is returned. If no memory allocation is tried, no problem due to a trial of the memory allocation is caused.

That is, if the judgment condition is appropriately defined so as to indicate a certain situation in which the procedure of trying the memory allocation possibly degrades the efficiency of a computer, the procedure of trying the memory allocation is prevented or postponed in the certain situation. As a result, the problems of reduced efficiency of a computer, stall, hang, etc. caused by the execution of the procedure of trying the memory allocation may be avoided. Thus, according to the first embodiment, the memory allocation is appropriately controlled.

Relating to the flowcharts F1 and F2 above, the details of the procedure may be varied. Described below are examples of the details of the procedure from some points of view.

For example, the program code for allowing a processor to perform the procedure of the flowchart F1 or F2 may be implemented at any of various levels of an application program, a library function, a system call (that is, a kernel function), a hook function, etc.

For example, an application program may include a first code that invokes a library function for memory allocation or a system call for memory allocation, and a second code that invokes the first code. The first code is a wrapper used in the application for memory allocation.

For example, the first code may be the code of a subroutine of the application. In this case, the second code is a code that invokes the subroutine from inside the application. Concretely, the second code may be the code of the main routine of the application, or the code of a subroutine other than that of the first code.

Otherwise, the first code may be a constructor of a certain class. In this case, the second code is a statement that explicitly or implicitly invokes the constructor.

When the processor executes an application program including the above-mentioned first and second codes, the procedure of the flowchart F1 or F2 is realized as follows.

By the processor invoking the first code from the second code during execution of the second code, a request for memory allocation is issued. Then, upon invocation of the first code from the second code, the processor starts executing the first code.

The processor accepts a request for the memory allocation as in step S101, by starting execution of the invoked first code. That is, the first code is a code that describes the operation according to the flowchart F1 or F2.

Therefore, the operation in step S103 is concretely realized as follows. That is, the processor tries to allocate a block of the memory (i.e., tries memory allocation) in step S103 by invoking a library function or a system call during execution of the first code invoked from the second code.

In addition, in step S104, the return value from the library function or the system call (or the return value generated from the return value above according to the first code) is returned from the first code to the second code. For example, when the memory allocation succeeds, the pointer which points to the head of the allocated memory area may be returned in step S104.

In addition, when the memory allocation fails in step S103, a NULL pointer may be returned in step S104, and a specific value may be set to a specific variable such as “errno” that indicates an error code. Otherwise, when the memory allocation fails in step S103, an exception may be thrown in step S104. In this case, the second code includes a code for catching the exception.

Similarly, in step S106, the result of the failure in allocation is returned from the first code to the second code. For example, in step S106, an exception may be thrown. Otherwise, step S106 may be a step of returning a NULL pointer and setting a specific value to a specific variable that indicates an error code.

Otherwise, the operation of the flowchart F1 or F2 may be concretely implemented at the level of a library function for memory allocation or a system call for memory allocation.

For example, the processor may execute an application program that invokes a library function or a system call for memory allocation. Then, the processor invokes the library function or the system call during execution of the application program.

By this invocation, a request for memory allocation is issued. By this invocation, the processor starts executing the library function or the system call. Then, the processor accepts the request for the memory allocation as in step S101 by starting the execution of the invoked library function or system call.

In addition, in step S104, a result of the trial of the memory allocation in step S103 is returned from the invoked library function or system call to the caller application program. Similarly, in step S106, a result that the memory allocation has failed is returned from the invoked library function or system call to the caller application program.

For example, in step S104, as in the example above, a pointer which points to the head of a memory area or a NULL pointer may be returned to the application program. In addition, in step S106, a NULL pointer may be returned, or an exception may be thrown. Furthermore, in step S106, a specific value may be set to a specific variable that indicates an error code.

Otherwise, a hook function for hooking a library function for memory allocation or a system call for memory allocation may be defined. Then, the operation of the flowchart F1 or F2 may be concretely described in the hook function.

For example, the processor may execute an application program including invocation of a library function or a system call for memory allocation. Then, the processor invokes the library function or the system call during execution of the application program.

The invocation is hooked and the processor starts executing the hook function. Although there are two aspects as described in items (2-1) and (2-2), the processor operates, in either aspect, according to the flowchart F1 or F2.

(2-1) The processor starts executing the library function or the system call, thereby accepting the request for memory allocation in step S101. Then, the processor starts executing the hook function.

(2-2) The processor starts executing the hook function, thereby accepting, inside the hook function, the request for memory allocation as in step S101.

The procedures in and after step S102 are common in the aspects 2-1 and 2-2. Concretely, the processor judges in step S102, by executing the hook function, whether or not a judgment condition holds.

If the judgment condition does not hold, the processor returns control from the hook function to the original library function or system call. Then the processor executes the original library function or system call invoked from the application program, thereby trying memory allocation in step S103. Then, in step S104, a result of indicating whether or not the memory allocation has succeeded (for example, the pointer similar to that in the example above) is returned to the application program.

On the other hand, when the judgment condition holds, the processor may wait for a specified time in step S105 according to the flowchart F1, and return control to the original library function or system call from the hook function. The subsequent processing in step S103 and S104 is identical to the processing performed when the judgment condition does not hold. Otherwise, when the judgment condition holds, the processor may return the result of allocation failure from the hook function in step S106 according to the flowchart F2.

As described above, the judgment condition in step S102 is a condition on the time taken by a processor to perform each of one or more specific procedures. For example, the above-mentioned “one or more specific procedures” may include at least one of the procedures 3-1 and 3-2.

(3-1) A procedure of acquiring the value indicating the amount or ratio (e.g., percentage) of memory usage after accepting a request in step S101

(3-2) A procedure of acquiring the value indicating the load of the processor (for example, the percentage of CPU usage) after accepting a request in step S101

The procedures 3-1 and 3-2 above may be the procedures in which the processor executes a command provided by the OS. For example, available are the “top” command, the “vmstat” command, the “free” command, the “uptime” command, etc. Otherwise, the procedures 3-1 and 3-2 may be those to execute a system call that is invoked from inside the above-mentioned commands.

For example, assume that the percentage of the memory usage turns out high as a result of the procedure 3-1, and that the percentage of the CPU usage turns out high as a result of the procedure 3-2. In this case, a computer is definitely in a heavy load state.

In addition, the time taken for the processor to perform the procedures 3-1 and 3-2 may also be the index of the state of the load of a computer. For example, the time taken for the processor to execute a command when the load of the entire computer is heavy is longer than the time taken for the processor to execute the same command when the load of the entire computer is low.

Therefore, the judgment condition in step S102 may be expressed by the combination of the conditions 4-1 through 4-3 below.

(4-1) For each individual specific procedure included in the above-mentioned one or more specific procedures, the time taken for the processor to perform the individual specific procedure is longer than a first threshold which is determined depending on the individual specific procedure.

(4-2) The amount of memory usage or the ratio of memory usage exceeds a second threshold.

(4-3) The load of the processor exceeds a third threshold.

Concretely, the judgment condition may be a logical disjunction of the condition 4-1 and a logical conjunction of the conditions 4-2 and 4-3. In this case, the judgment condition is formally defined as follows.

First, as in formula (1), let P be a set of one or more specific procedures. In formula (1), 1≦N.

P={p₁, . . . ,p_{N}} (1)

Furthermore, let t(pⱼ) be the time taken for the processor to perform a specific procedure pⱼ (1≦j≦N) which belongs to the set P. The condition 4-1 is expressed as the condition C₁ of the formula (2) using the thresholds T₁ through T_{N}. The thresholds T₁ through T_{N} may be different from each other, or the same value.

C₁=(t(p₁)>T₁) [symbol] . . . [symbol] (t(p_{N})>T_{N}) (2)

Then, let m be the amount of memory usage obtained from the procedure 3-1, and let M be the threshold relating to the amount of memory usage. Otherwise, let m be the ratio (e.g., percentage) of memory usage obtained from the procedure 3-1, and let M be the threshold relating to the ratio of memory usage. Then, the condition 4-2 may be expressed as the condition C₂ in the formula (3).

C₂=(m>M) (3)

Furthermore, let u be the load of the processor obtained from the procedure 3-2, and let U be the threshold about the load of the processor. Then, the condition 4-3 is expressed as the condition C₃.

C₃=(u>U) (4)

Then, the judgment condition in step S201 in FIG. 1 may be the condition C expressed by formula (5) using the conditions C₁ through C₃ of formulas (2) through (4).

C=C₁ [symbol] (C₂ [symbol] C₃) (5)

As expressed by formula (5), the logical conjunction of the conditions C₂ and C₃ is used for the judgment condition C. That is, it is judged whether or not both of the conditions C₂ and the C₃ hold. On the other hand, the above-mentioned one or more specific procedures does not always include both of the procedures 3-1 and 3-2, and at least one of them is sufficient for the following reasons.

If the amount or the percentage of memory usage is low, there is a strong likelihood that the trial of memory allocation will succeed although it may sometimes take a long time depending on the load of the CPU. If the load of the CPU is low, it is predicted that the procedure of releasing the memory which is being temporarily used by the OS will proceed smoothly and normally. Therefore, there is a strong likelihood that the trial of the memory allocation will succeed. Accordingly, when only one of the condition C₂ and the condition C₃ holds, it is not sufficient to determine that there is a strong likelihood that the trial of the memory allocation will fail.

On the other hand, the fact that the time taken for the processor to perform a certain procedure is much longer than the standard time to be taken to perform the certain procedure is a evidence enough to indicate that the entire computer has entered a heavy load state. Therefore, it is sufficient for the above-mentioned one or more specific procedures to include at least one of the procedures 3-1 and 3-2.

Obviously, it is preferable that the one or more specific procedures include both of the procedures 3-1 and 3-2. This is because the number of evidences indicating that the entire computer has entered the heavy load state increases, and thereby the judgment in step S102 in FIG. 1 becomes furthermore correct.

However, it is acceptable that the one or more specific procedures do not include the procedure 3-1 or 3-2, but includes the procedure which has been performed within a latest specified range of time and in which the processor has tried to allocate a block of the memory at a request to allocate the block of the memory. In this case, the judgment condition may be a condition that the time taken in the latest specified range of time for the processor to reach a result of trying to allocate the block of the memory (i.e., the time taken for the previous trial of the memory allocation performed within the specified range of time) is longer than a threshold, or may be a logical disjunction of this condition and any other condition(s).

For example, when N=1 in formula (1), the judgment condition C may be the condition C₁ in formula (2). That is, when N=1, the judgment condition C may be the condition in formula (6). In this case, only one specific procedure p₁ is the procedure of trying memory allocation by the processor previously in the specified range at a request for the memory allocation.

C=C₁=(t(p₁)>T₁) (6)

Otherwise, regardless of the value of N, the judgment condition C may be the condition in formula (7). Let the specific procedure p₁ in formula (7) be a procedure of trying memory allocation by the processor at a request for the memory allocation previously in a specified range.

C=(t(p₁)>T₁) [symbol] C₄ (7)

The condition C₄ in formula (7) may be any condition. For example, when 1<N, the condition C₄ may be a function of the times t (p₂) through t (p_{N}) taken by the processor to perform the remaining specific procedures p₂ through p_{N}.

When the procedure of trying memory allocation by the processor at a request for the memory usage previously in a specified range is processed as a specific procedure, it is preferable that the length of the “specified time” in step S105 in FIG. 1 is not less than the length of a specified range for the following reason.

To maintain the condition C of formula (6) or (7) as an appropriate judgment condition, it is preferable that the length of the specified range is the length which does not largely change the state of the load on the entire computer. That is, it is preferable that the specified range is not so long.

Since the judgment condition C is a condition for prediction as to whether or not there is a strong likelihood that a trial fails if the processor tries memory allocation at the present point in time, it is not preferable that very old data is used for the judgment condition C. Therefore, it is preferable that the specified range is not very long.

On the other hand, it is preferable that the specified time in step S105 is long to a certain extent because the purpose of the processing in step S105 is to postpone the trial of memory allocation until a very heavy load which possibly makes the trial of the memory allocation result in failure is reduced to the level at which there is a strong likelihood that the trial of the memory allocation will succeed. It is preferable that the specified time is set long to a certain extent to fulfill this purpose.

Thus, it is preferable that the specified range is not very long, and the specified time is long to a certain extent.

Therefore, it is preferable that the specified time is longer than the specified range.

The explanation above may also be described as follows.

Control is passed from step S102 to step S105 if a trial of memory allocation has failed as lately as this failure is useful in predicting whether or not the trial of the memory allocation at the present point in time will succeed. In this case, if the wait time in step S105 is shorter than the elapsed time from this failure to the present point in time, there is a small likelihood for such a short time to sufficiently reducing the load of the entire computer. Therefore, there is a strong possibility that the trial in step S103 after step S105 fails.

That is, the wait time shorter than the specified range is not long enough to suppress wasteful resource consumption, in many cases. Therefore, to suppress wasteful resource consumption in a heavy load state and enhance the possibility of successful memory allocation, it is preferable that the specified time in step S105 is set sufficiently long so that the specified time is not less than the specified range.

The above-mentioned one or more specific procedures may be determined as follows using appropriate α and β that satisfy 1≦α≦β≦N for N in formula (1). Concretely, the one or more specific procedures may include latest β trials included in a plurality of trials of memory allocation performed by the processor previously.

For example, when β=N for convenience of explanation below, the judgment condition may be a condition that, for each trial of at least α trials included in the latest β trials, the time taken for the processor to reach a result of this trial is longer than a threshold. For example, when α=2 and β=3, the judgment condition C is expressed by formula (8) using a 3-input majority function f and a threshold T.

C=ƒ((t(p₁)>T), (t(p₂)>T), (t(p₃)>T)) (8)

When the procedure of trying memory allocation by the processor previously is regarded as a specific procedure, the time taken for the processor to perform the specific procedure means a time taken to know whether or not the trial of memory allocation has succeeded. The threshold (for example, the threshold T₁ in formula (6) or (7) or the threshold T in formula (8)) to be compared with this time may be a value depending on the memory size having been requested in the previous try by the processor at allocating a block of the memory. This is because the time taken for a procedure of trying to allocate a block of the memory may depend on the requested memory size.

For example, if the requested memory is very large in size, it may take a relatively long time to search for an allocatable memory area. Then, even if memory allocation succeeds at the first trial, it may take a long time for the processor to try to allocate a block of the memory and succeed in the allocation.

On the other hand, when allocation of a block of the memory of a small size is requested, a search may be done in a short time, in many cases. Therefore, the average time taken for the processor to try to allocate a block of the memory and succeed in the memory allocation is relatively short.

Therefore, a threshold depending on a memory size may be used.

If the processor succeeds in the memory allocation as a result of a trial of memory allocation in step S103, the processor returns a result of success in the memory allocation in step S104. In addition, if the processor fails in the memory allocation as a result of a trial of memory allocation in step S103, the processor may simply return a result in step S104, but may instead perform a different operation depending on the following cases 5-1 through 5-3.

(5-1) If the time taken to know that a try at allocating a block of the memory has resulted in failure is longer than a threshold, then the processor returns, in step S104, a result that the memory allocation has failed.

(5-2) If the time taken to know that the try at allocating the block of the memory has resulted in failure is shorter than the threshold, and the number of tries at allocating the block of the memory does not reach a specified number of times, then the processor tries to allocate the block of the memory again.

(5-3) If the memory allocation does not succeed even after the number of tries at allocating the block of the memory reaches the specified number of times, then the processor returns a result that the memory allocation has failed.

If not only the trial of memory allocation fails, but it takes a long time just to know the result of failure in trying the memory allocation, then it is an evidence that the load of the entire computer is very heavy. Therefore, the processor may operate depending on the length of time as in the procedures 5-1 and 5-2.

Otherwise, the processor may operate in the next procedures 6-1 and 6-2 when the memory allocation fails as a result of trying the memory allocation in step S103.

(6-1) Unless the number of tries at allocating a block of the memory reaches a specified number of times, the processor tries again memory allocation.

(6-2) If the memory allocation does not succeed even after the number of tries at allocating the block of the memory reaches the specified number of times, then the processor returns a result that the memory allocation has failed.

It is preferable that the processor waits for an appropriate time before trying the memory allocation again as in the procedures 5-2 and 6-1.

Described next is the configuration of the computer operating according to the flowchart F1 or F2 in FIG. 1. FIG. 2 is a block diagram of a computer according to the first embodiment.

A computer 100 in FIG. 2 is a type of information processing device. The computer 100 includes memory 101, a program execution unit 102, a specific procedure execution unit 103, a request acceptance unit 104, a judgment unit 105, and a memory allocation control unit 106. The computer 100 stores one or more parameters 107 used by the judgment unit 105.

The memory 101 may be, for example, DRAM.

The program execution unit 102 executes a program using an area dynamically allocated on the memory 101. The program executed by the program execution unit 102 may be, for example, a user application, and the program includes a code for requesting memory allocation.

The specific procedure execution unit 103 performs one or more specific procedures by a program other than the above-mentioned program executed by the program execution unit 102. The one or more specific procedures are described above relating to the judgment condition in step S102 in FIG. 1.

For example, when the procedure 3-1 is a specific procedure, the specific procedure execution unit 103 performs the procedure 3-1. For example, the specific procedure execution unit 103 may perform the procedure 3-1 by executing a specified command or system call.

Otherwise, when the procedure 3-2 is a specific procedure, the specific procedure execution unit 103 performs the procedure 3-2. For example, the specific procedure execution unit 103 may perform the procedure 3-2 by executing a specified command or system call.

Otherwise, as described above, the procedure of trying memory allocation by a processor at a request for memory allocation to the memory previously in a specified range may be a specific procedure. In this case, the specific procedure execution unit 103 may perform a specific procedure by executing a library function or system call for memory allocation.

The request acceptance unit 104 accepts a request for memory allocation from the program execution unit 102 in step S101 in FIG. 1.

Then the judgment unit 105 judges in step S102 whether or not a judgment condition holds. The judgment condition is related to the time taken for the specific procedure execution unit 103 to perform each of one or more specific procedures as described above. That is, the judgment unit 105 acquires a result of judgment about the probability of success or failure in memory allocation.

The judgment by the judgment unit 105 is performed based on one or more parameters 107. An example of the parameter 107 is a threshold in formulas (2) through (4) and (6) through (8).

The memory allocation control unit 106 operates depending on the result of judgment by the judgment unit 105.

FIG. 2 illustrates the judgment unit 105 separately from the memory allocation control unit 106, but the memory allocation control unit 106 may includes the judgment unit 105.

Concretely, when the judgment condition does not hold, the memory allocation control unit 106 tries memory allocation in step S103 at a request for memory allocation, and returns a result in step S104.

On the other hand, when the judgment condition holds, the memory allocation control unit 106 waits for a specified time in step S105 according to the flowchart F1, and then tries memory allocation in step S103. That is, when the result of judgment in step S102 indicates that there is a high probability of failure in the memory allocation, the memory allocation control unit 106 tries memory allocation with a delay.

Otherwise, when the judgment condition holds, the memory allocation control unit 106 returns a result of failure in memory allocation in step S106 at a request for memory allocation according to the flowchart F2. That is, when the result of judgment in step S102 indicates that there is a high probability of failure in memory allocation, the memory allocation control unit 106 returns a reply that the memory allocation has failed without trying the memory allocation.

The result as to whether or not the memory allocation has succeeded is returned from the memory allocation control unit 106 to the program execution unit 102. If the memory allocation has succeeded, the program execution unit 102 executes the program using the allocated area on the memory 101.

In FIG. 2, the broken lines connect the memory allocation control unit 106 to the specific procedure execution unit 103, and the specific procedure execution unit 103 to the memory 101. The alternate long and short dashed line connects the memory allocation control unit to the memory 101. The difference in type of line indicates the difference in specific procedure.

That is, when the procedure of trying memory allocation is a specific procedure, the memory allocation control unit 106 tries the memory allocation by invoking the specific procedure execution unit 103 in step S103. Then, the practical concrete procedure for the memory allocation (for example, a procedure of searching for an allocatable memory area) is performed by the specific procedure execution unit 103. A result as to whether or not a trial of the memory allocation has succeeded is returned from the specific procedure execution unit 103 to the memory allocation control unit 106. Therefore, the memory allocation control unit 106 returns the result returned from the specific procedure execution unit 103 to the program execution unit 102 in step S104.

On the other hand, when the procedure of trying memory allocation is not a specific procedure, the memory allocation control unit 106 may perform a practical concrete procedure. Otherwise, the memory allocation control unit 106 may try memory allocation in step S103 by invoking a system call for memory allocation. In this case, a system call execution unit not illustrated in FIG. 2 may perform a practical concrete for memory allocation depending on the invocation from the memory allocation control unit 106.

The computer 100 in FIG. 2 may be concretely realized by, for example, the hardware illustrated in FIG. 3. FIG. 3 is a hardware configuration diagram of a computer common among the first through third embodiments.

A computer 200 in FIG. 3 includes a CPU 201, RAM (random access memory) 202, ROM (read only memory) 203, a communication interface 204, an input device 205, an output device 206, a storage device 207, and a drive device 208 of a storage medium (i.e., recording medium) 210. The components in the computer 200 are connected to a bus 209.

The CPU 201 loads a program into the RAM 202, uses the RAM 202 also as a working area, and executes the program. Although FIG. 3 illustrates only one CPU 201, the computer 200 may be a multiprocessor system including a plurality of CPUs 201.

The RAM 202 may be, for example, DRAM. Furthermore, an MMU may be included in the CPU 201. Otherwise, an MMU may be provided externally to the CPU 201, and the RAM 202 may be connected to the bus 209 through the MMU. The ROM 203 may be, for example, EEPROM (electrically erasable programmable read-only memory) such as flash memory etc.

The program executed by the CPU 201 may be stored in the ROM 203 or the storage device 207 in advance. The storage device 207 may be, for example, an HDD (hard disk drive).

Otherwise, a program may be provided by a program provider 212, downloaded to the computer 200 through a network 211 and the communication interface 204, and stored in the storage device 207. The program provider 212 is, for example, another computer.

Furthermore, the program may be provided as being stored in the computer-readable and portable storage medium 210. The program is read by the drive device 208 from the storage medium 210 set in the drive device 208. The read program may be then temporarily copied to the storage device 207 and loaded to the RAM 202, or directly loaded to the RAM 202. As the storage medium 210, an optical disk such as a CD (compact disc), a DVD (digital versatile disc), etc., a magneto optical disk, a magnetic disk, a nonvolatile semiconductor memory card, etc. are available.

The communication interface 204 is, for example, a cable LAN (local area network), an interface device, a wireless LAN interface device, or a combination of them. Furthermore, the input device 205 is, for example, a keyboard, a pointing device such as a mouse, a touch screen, etc., a microphone, or a combination of them. The output device 206 is, for example, a display, a speaker, or a combination of them. The display may be a touch screen.

The RAM 202, the ROM 203, the storage device 207, and the storage medium 210 are examples of a computer-readable storage medium. These computer-readable storage media are tangible storage media, and are not transitory media.

The relationship between FIGS. 2 and 3 is described below.

The memory 101 in FIG. 2 corresponds to the RAM 202 in FIG. 3. The program execution unit 102, the specific procedure execution unit 103, the request acceptance unit 104, the judgment unit 105, and the memory allocation control unit 106 in FIG. 2 are realized by executing a program by the CPU 201 in FIG. 3.

The parameter 107 in FIG. 2 is stored in the RAM 202 in FIG. 3. More concretely, the parameter 107 may be stored in advance with a program in, for example, the ROM 203, the storage device 207, or the storage medium 210, and then read to the RAM 202.

Otherwise, the parameter 107 may be downloaded with a program through the network 211 and the communication interface 204 from the program provider 212, and then be read to the RAM 202. The parameter 107 may also be set on the RAM 202 at an instruction from the input device 205.

Then, the second embodiment is described with reference to FIGS. 4 through 10B. FIG. 4 is a block diagram of a computer common between the second and third embodiments.

A computer 300 may be concretely realized by the computer 200 in FIG. 3. In FIG. 4, the components of the computer 300 are illustrated separately in three layers, that is, an application 301, an OS 302, and hardware 303. The application 301 according to the second embodiment is a system test program for testing the performance of the computer 300. Concretely, the hardware 303 includes various types of hardware devices as illustrated in FIG. 3.

Then, the layer of the application 301 includes a system test unit 304. The system test unit 304 is realized by executing the application 301 by the CPU 201. In more detail, the system test unit 304 includes a test control unit 305, a CPU test execution unit 306, a memory test execution unit 307, a disk test execution unit 308, a network test execution unit 309, an information acquisition unit 310, and a memory acquisition unit 311. The operation of each unit in the system test unit 304 is described later with reference to the flowchart.

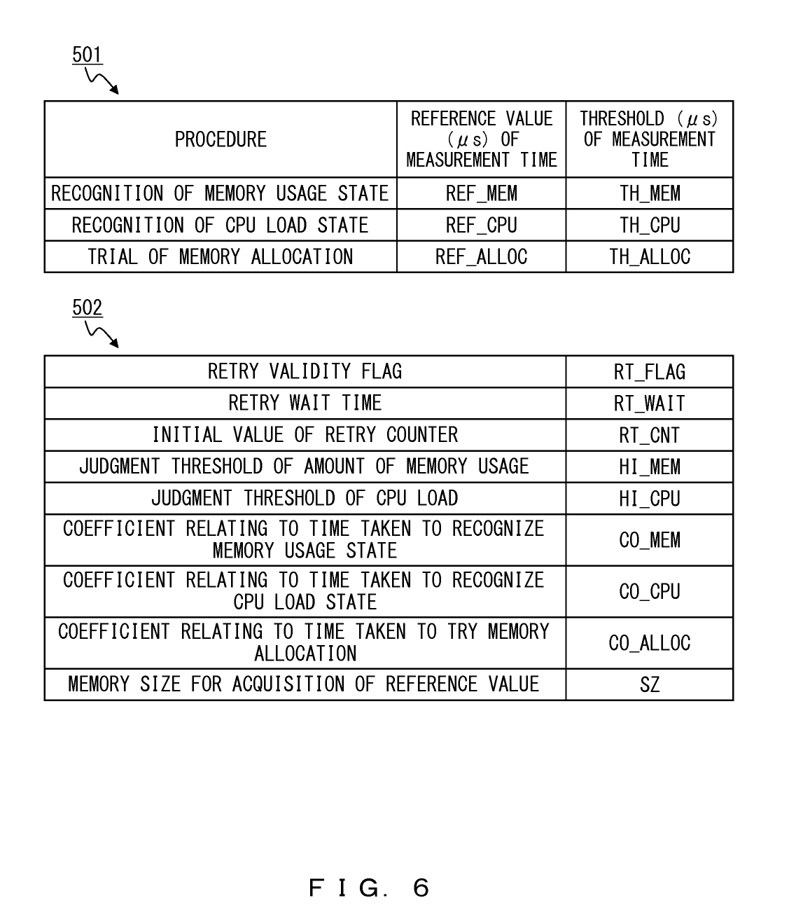

The layer of the application 301 includes a management table 312 and a constant data 313 used by the system test unit 304. Concrete examples of the management table 312 and the constant data 313 according to the second embodiment are described later with reference to FIG. 6.

The management table 312 is generated on the RAM 202 in FIG. 3 by executing the application 301 by the CPU 201. On the other hand, the constant data 313 may be stored in advance with a program in, for example, the ROM 203, the storage device 207, or the storage medium 210, and then read to the RAM 202.

Otherwise, the constant data 313 may be downloaded with a program from the program provider 212 through the network 211 and the communication interface 204. Then, it may be read to the RAM 202. Otherwise, the constant data 313 may be user defined. That is, upon receipt of input from the input device 205, the constant data 313 is set and may be stored in the RAM 202.

The layer of the OS 302 includes a CPU load measurement unit 314, a memory usage amount measurement unit 315, a time measurement unit 316, a memory acquisition and release unit 317, a kernel 318, and a driver 319.

The CPU load measurement unit 314 and the memory usage amount measurement unit 315 are realized by the CPU 201 executing a specific command (for example, a “top” command) or a system call provided by the OS 302.

The time measurement unit 316 acquires the starting and ending times of a process, and measures the length of the time taken to execute the process. The time acquisition function by the time measurement unit 316 may be realized by, for example, executing the library function or system call for acquiring the current time by the CPU 201.

It is assumed that the time measurement unit 316 has a very fine time resolution. That is, it is assumed that the time measurement unit 316 may acquire the time with sufficient accuracy so that the calculated run time of the process is not zero.

The memory acquisition and release unit 317 acquires memory (concretely the RAM 202 in FIG. 3) at a request (that is, allocates memory). In addition, the memory acquisition and release unit 317 releases the allocated memory at a request.

The memory acquisition and release unit 317 may concretely be realized by the CPU 201 executing the library function (for example, malloc( ) function and free( ) function) for allocation and release of memory. Otherwise, the memory acquisition and release unit 317 may be realized by the CPU 201 executing a system call for allocation and release of memory.

The library function for allocation and release of memory includes the invocation of a system call. That is, the memory acquisition and release unit 317 concretely allocates and releases memory by invoking the kernel 318.

Depending on the implementation of a library function, for example, the malloc( ) function may include the invocation of the mmap( ) function as a system call. Furthermore, the free( ) function may include the invocation of the munmap( ) function as a system call.

The driver 319 is a device driver for the hardware 303 (for example, the input device 205, the output device 206, the storage device 207, the drive device 208, etc.).

The relationship between FIGS. 2 and 4 is described below.

The hardware 303 in FIG. 4 includes memory (for example, the RAM 202 in FIG. 3) similar to the memory 101 in FIG. 2. The CPU test execution unit 306, the memory test execution unit 307, the disk test execution unit 308, and the network test execution unit 309 in FIG. 4 may request memory allocation like the program execution unit 102 in FIG. 2.

The memory acquisition unit 311 in FIG. 4 performs the procedure like the request acceptance unit 104, the judgment unit 105, and the memory allocation control unit 106 in FIG. 2. The values corresponding to the parameter 107 in FIG. 2 are stored in the management table 312 and the constant data 313.

In the second embodiment, the CPU load measurement unit 314 and the memory usage amount measurement unit 315 in FIG. 4 correspond to the specific procedure execution unit 103 in FIG. 2. In the third embodiment described later, the memory acquisition and release unit 317 in FIG. 4 corresponds to the specific procedure execution unit 103 in FIG. 2.

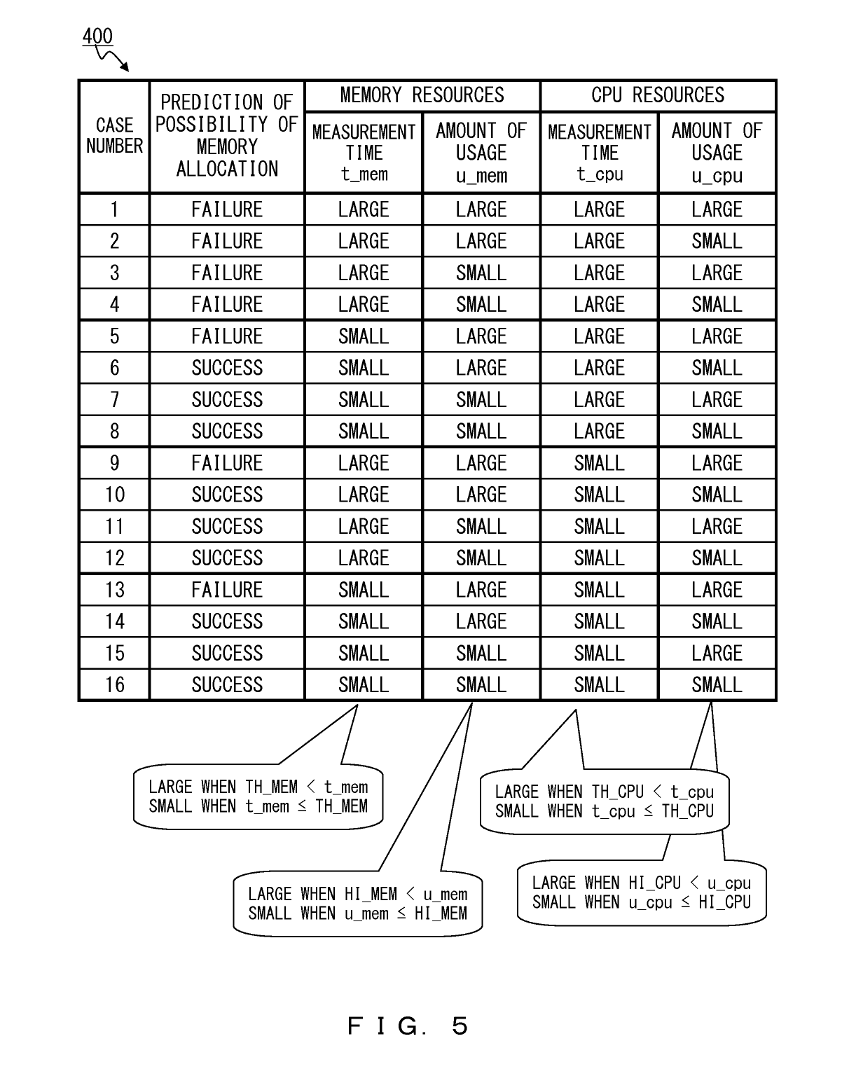

Then, the outline of the memory allocation control method according to the second embodiment is described below with reference to FIG. 5. In the second embodiment, the memory allocation is controlled by the memory acquisition unit 311 performing the method similar to the flowchart F2 in FIG. 1.b

As described above with reference to the first embodiment, the judgment condition in step S102 in the flowchart F2 is the condition on the time taken for the processor to perform each of one or more specific procedures. Then, concretely according to the second embodiment, the number of specific procedures is 2. That is, the value of N in formulas (1) and (2) explained above according to the first embodiment is 2 in the second embodiment. Then, in the second embodiment, the judgment condition C in formula (5) is used. More concretely explanation is given below.

The first specific procedure according to the second embodiment is the procedure of acquiring the value indicating the amount of usage of memory resources like in the procedure 3-1 above. Concretely, the first specific procedure is the procedure of acquiring the value indicating the amount of usage of memory (that is, the RAM 202 in FIG. 3) by the memory usage amount measurement unit 315 in FIG. 4.

For convenience of explanation below, the value obtained by the memory usage amount measurement unit 315 is expressed as “u_mem”. The amount of usage u_mem corresponds to “m” in formula (3).

The second specific procedure is the procedure of acquiring the value indicating the amount of usage of CPU resources (that is, the load of the CPU 201). Concretely, the second specific procedure is the procedure of the CPU load measurement unit 314 in FIG. 4 acquiring the value indicating the amount of usage of the CPU 201 in FIG. 3. The amount of usage of the CPU 201 may be concretely expressed by CPU time, and may be expressed as a percentage of CPU usage.

For convenience of explanation below, the value obtained by the CPU load measurement unit 314 is expressed as “u_cpu”. The amount of usage u_cpu corresponds to “u” in formula (4).

The time measurement unit 316 in FIG. 4 measures the time taken for the memory usage amount measurement unit 315 to perform the first specific procedure. For convenience of explanation below, the measured time is expressed as “t_mem”. The measurement time t_mem corresponds to “t(p₁)” in formula (2).

The time measurement unit 316 also measures the time taken for the memory usage amount measurement unit 315 to perform the second specific procedure. For convenience of explanation below, the measured time is expressed as “t_cpu”. The measurement time t_cpu corresponds to “t(p₂)” in formula (2).

In the second embodiment, the threshold TH_MEM about the measurement time t_mem and the threshold TH_CPU about the measurement time t_cpu are calculated in advance and stored in the management table 312. The thresholds TH_MEM and TH_CPU respectively correspond to “T₁” and “T₂” in formula (2).

Also in the second embodiment, the threshold HI_MEM about the amount of memory usage u_mem and the threshold HI_CPU about the amount of CPU usage are determined in advance and stored as the constant data 313 in the computer 300. The thresholds HI_MEM and HI_CPU respectively correspond to “M” in formula (3) and “U” in formula (4).

An explanatory view 400 in FIG. 5 illustrates 16 possible cases. In FIG. 5, the column 1 indicates the case number.

The column 2 indicates a result of judgment by the memory acquisition unit 311 (that is, the prediction about memory allocatability). The memory acquisition unit 311 judges, by a method similar to the method performed by the judgment unit 105 in FIG. 2, as to whether or not the judgment condition holds.

The case in which the judgment condition does not hold refers to the case in which there is a strong likelihood that memory allocation will succeed. That is, it refers to the case in which the memory acquisition unit 311 predicts that memory may be allocated. In this case, the column 2 expresses “allocatable” in FIG. 5.

On the other hand, the case in which the judgment condition holds refers to the case in which there is a strong likelihood that memory allocation will fail. That is, it refers to the case in which the memory acquisition unit 311 predicts that memory is not allocatable. In this case, the column 2 expresses “not allocatable” in FIG. 5.

In the column 3, “large” is described if TH_MEM<t_mem, and “small” is described if t_mem≦TH_MEM. In the column 4, “large” is described if HI_MEM<u_mem, and “small” is described if u_mem≦HI_MEM.

In the column 5, if TH_CPU<t_cpu, “large” is described, and “small” is described if t_cpu≦TH_CPU. In the column 6, “large” is described if HI_CPU<u_cpu, and “small” is described if u_cpu≦HI_CPU.

Therefore, as a combination of the values in columns 3 through 6, 16 (=2⁴) patterns are expressed. In FIG. 5, the column 2 describes “allocatable” or “not allocatable” as results of judgment of the memory acquisition unit 311 on the 16 patterns.

Concretely, as indicated by the cases 1 through 4, when the measurement time t_mem and the measurement time t_cpu describe “large”, the computer 300 is in a high load state in which it takes a long time only to execute a specified command. Therefore, the memory acquisition unit 311 predicts that memory is not allocatable in the cases 1 through 4.

As indicated in the cases 5, 9, and 13, when both amount of memory usage u_mem and amount of CPU usage u_cpu are “large”, the memory acquisition unit 311 predicts that memory is not allocatable because the amount of available memory is small, and the load of the CPU 201 is heavy.

In the memory being used, there may be an area being temporarily used by the OS as a buffer for disk I/O. Then, there is the possibility that the buffer area being temporarily used is released by the OS in a short time, and becomes available from an application. However, when the load of the CPU 201 is heavy, it takes relatively a long time to wait before the CPU 201 starts performing the procedure of releasing the buffer area to be available from an application, and to perform the procedure by the CPU 201. That is, it takes a relatively long time to increase an allocatable amount of memory.

Therefore, when the amount of CPU usage u_cpu is “large”, it is hard to predict that the amount of memory usage decreases by the CPU 201 performing the procedure of releasing the buffer area being temporarily used, and as a result there is a strong likelihood that new memory allocation will succeed. Therefore, in the cases 5, 9, and 13, the memory acquisition unit 311 predicts that memory is not allocatable as described above.

On the other hand, although the measured amount of memory usage u_mem is “large”, there is the possibility that memory allocation will succeed in a short time if the amount of CPU usage u_cpu is “small”. Therefore, in the cases 6, 10, and 14, the memory acquisition unit 311 predicts that memory allocation may be performed.

In the second embodiment, retry control is performed as described later. Therefore, it is considered that the process by the OS is performed and the amount of available memory increases while the wait time for a retry passes. Therefore, as in the cases 6, 10, and 14, if there is a strong likelihood that memory allocation will succeed in a short time, the memory acquisition unit 311 predicts that the memory allocation will be allocatable.

In the second embodiment, the memory acquisition unit 311 does not confirm what amount of memory capacity is temporarily used practically by the OS in the amount of memory usage u_mem measured by the memory usage amount measurement unit 315. If the memory acquisition unit 311 performs the confirmation above, the correctness of the prediction is enhanced, but an overhead for the confirmation arises. Accordingly, in the second embodiment, the memory acquisition unit 311 does no perform the above-mentioned confirmation by considering the balance between the overhead and the correctness of the prediction.

As in the cases 7, 11, and 15, if the measured amount of memory usage u_mem is “small” although the measured amount of CPU usage u_cpu is “large”, then the memory acquisition unit 311 predicts that memory allocation may be performed because the amount of memory usage u_mem is “small” which indicates that there is sufficient memory available.

Since the amount of CPU usage u_cpu is “large”, there is the possibility that a certain wait time arises until the CPU 201 may practically start the procedure for memory allocation. However, since there is available memory, there is a strong likelihood that memory allocation will succeed if the CPU 201 practically starts the procedure for memory allocation. Therefore, the memory acquisition unit 311 predicts that memory allocation may be performed.

As in the cases 8, 12, and 16, if both of the amount of CPU usage u_cpu and the amount of memory usage u_mem are “small”, there is available memory, and the CPU 201 may start the execution of the procedure for memory allocation relatively soon. Then, there is a strong likelihood that the memory allocation will succeed. Therefore, the memory acquisition unit 311 predicts that the memory allocation may be performed.

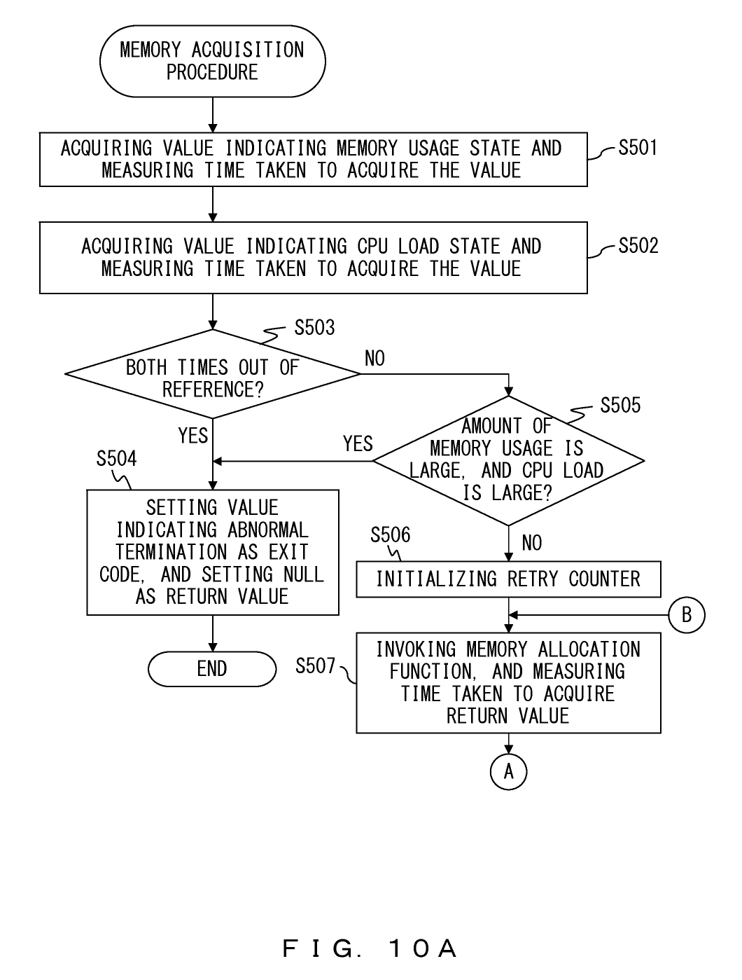

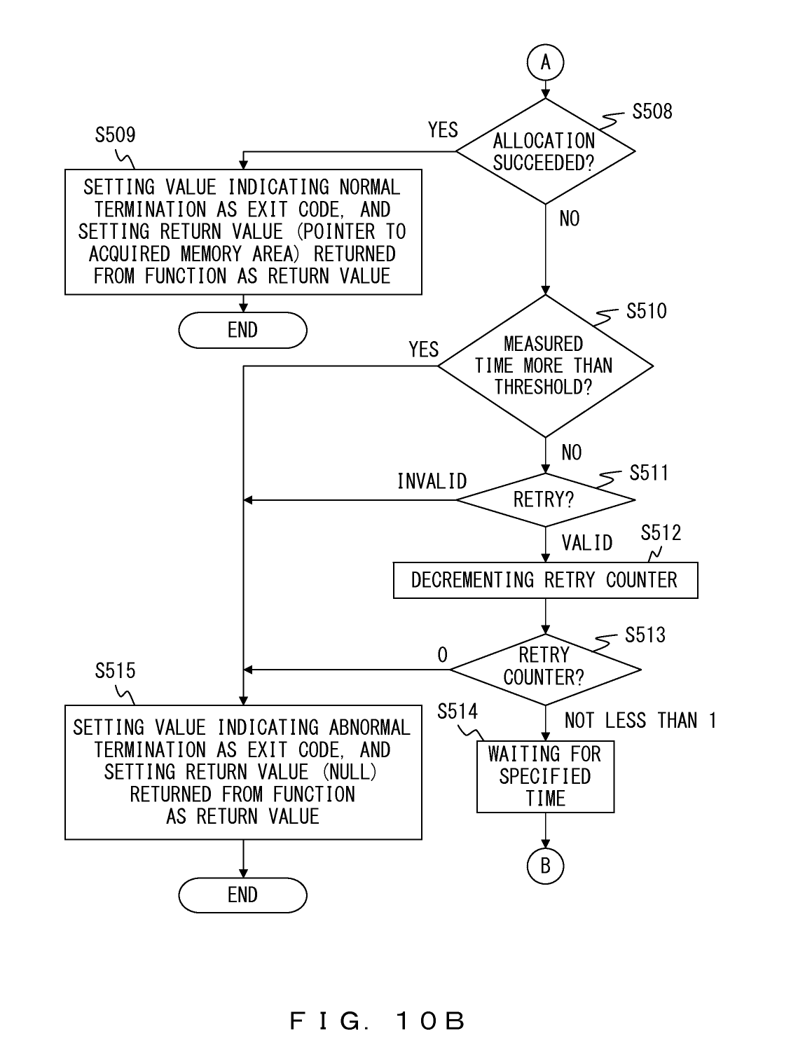

The memory allocation control method according to the second embodiment described above is described later in detail with reference to the flowchart in FIGS. 10A and 10B.

FIG. 6 illustrates the data used in the second embodiment. FIG. 6 exemplifies a management table 501 and constant data 502 as a concrete example of the management table 312 and the constant data 313 in FIG. 4.

The management table 501 includes the reference value and the threshold relating to the time taken to perform each of three types of procedures. In the example in FIG. 6, the unit of the reference value and the threshold is μs (microsecond).

Concretely, the row 1 of the management table 501 stores the reference value REF_MEM and the threshold TH_MEM relating to the time t_mem taken for the memory usage amount measurement unit 315 to recognize the memory usage state (that is, to acquire the value of the amount of memory usage u_mem). The threshold TH_MEM is a threshold described above relating to the column 3 in FIG. 5

The line 2 of the management table 501 stores the reference value REF_CPU and the threshold TH_CPU relating to the time t_cpu taken for the CPU load measurement unit 314 to recognize the CPU load state (that is, to acquire the value of the amount of CPU usage u_cpu). The threshold TH_CPU is a threshold described above relating to the column 5 in FIG. 5.

The line 3 of the management table 501 stores the reference value REF_ALLOC and the threshold TH_ALLOC relating to the time taken for the memory acquisition and release unit 317 to invoke the kernel 318 and try memory allocation. The threshold TH_ALLOC is referred to in the retry control described later with reference to FIGS. 10A and 10B. The threshold TH_ALLOC is also an example of the threshold in procedures 5-1 and 5-2 described above.

The constant data 502 includes a retry validity flag RT_FLAG expressed by the value of true or false as to whether or not the retry control is valid. Then, the constant data 502 includes the retry wait time RT_WAIT and the retry counter initial value RT_CNT referred to when the retry validity flag RT_FLAG is true.

Furthermore, the constant data 502 also includes the judgment threshold HI_MEM of the amount of memory usage and the judgment threshold HI_CPU of the CPU load described with reference to FIG. 5.

The three thresholds in the management table 501 are described later in detail, but the reference value corresponding to each of them is multiplied by a coefficient for calculation. The constant data 502 includes coefficients.

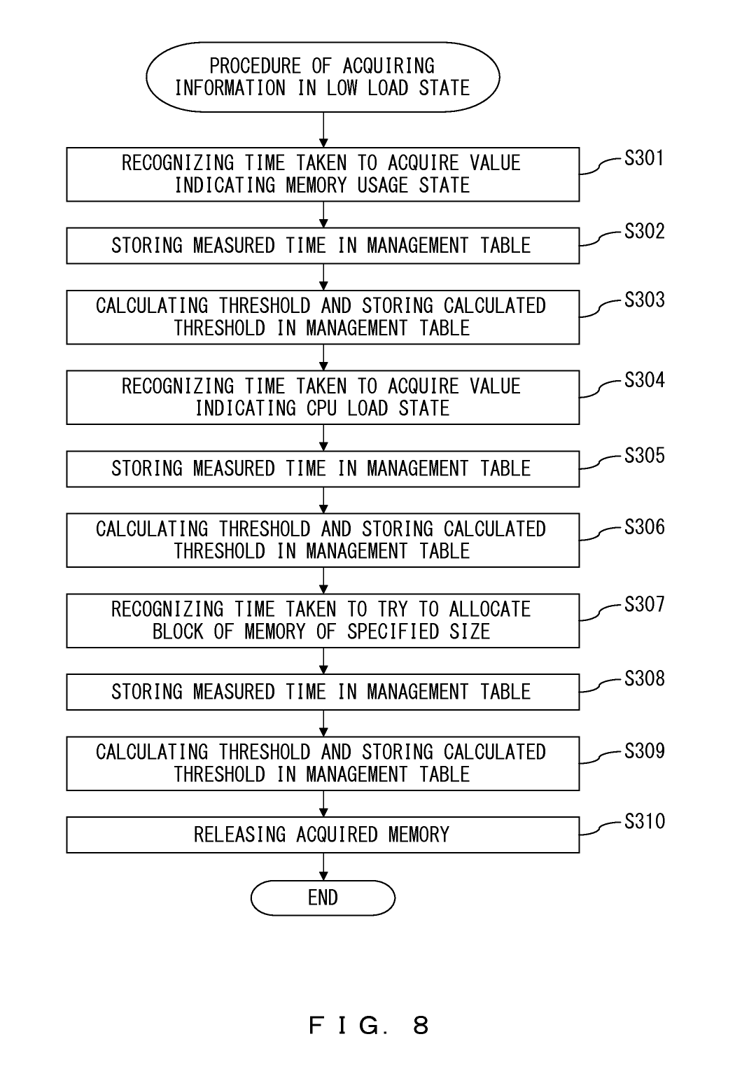

Concretely, the constant data 502 includes the coefficient CO_MEM about the time taken to recognize the memory usage state, the coefficient CO_CPU about the time taken to recognize the CPU load state, and the coefficient CO_ALLOC about the time taken to try memory allocation (i.e., the time taken to try to allocate a block of memory). As described later in detail with reference to FIG. 8, the threshold in the management table 501 is calculated from the reference value using the coefficients above by formulas (9) through (11).

TH_MEM=REF_MEM×CO_MEM (9)

TH_CPU=REF_CPU×CO_CPU (10)

TH_ALLOC=REF_ALLOC×CO_ALLOC (11)

The three coefficients above may be set to appropriate values based on, for example, a preliminary experiment. Otherwise, the value of a coefficient may be determined based on the input from the input device 205.

Although described later in detail, the memory acquisition and release unit 317 tries to allocate a block of the memory of a specified size SZ in order to acquire the reference value REF_ALLOC in the management table 501. The value of the specified size SZ is also included in the constant data 502. For example, the page size defined by the OS 302 may be set in the constant data 502 as the specified size SZ.

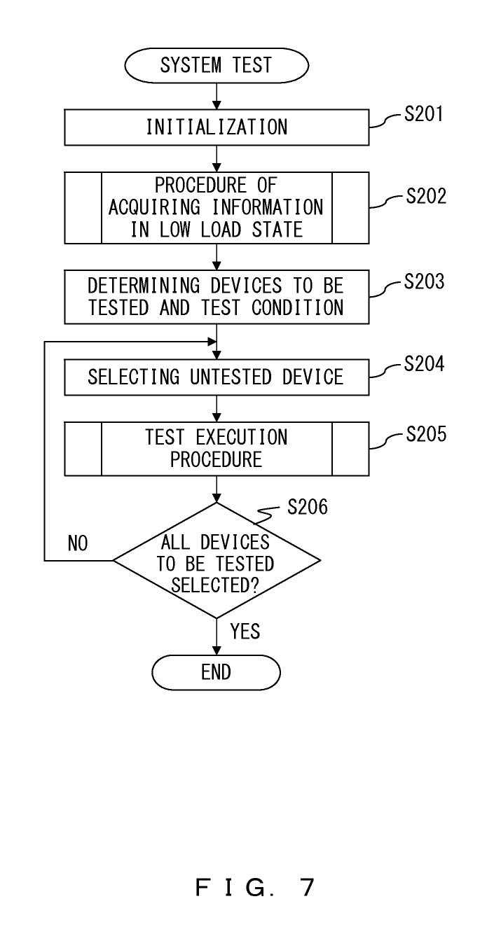

The operation of the computer 300 according to the second embodiment is described below further in detail with reference to the flowchart in FIGS. 7 through 10B.

FIG. 7 is a flowchart of a system test common between the second and third embodiments. For example, when the input of an instruction to start a system test is accepted by the input device 205 in FIG. 3, the test control unit 305 in FIG. 4 starts the procedure in FIG. 7.

In step S201, the test control unit 305 performs initialization. Concretely, the test control unit 305 initializes the management table 312. For example, in the second embodiment, the management table 312. For example, in the second embodiment, the management table 312 is the management table 501 concretely. Therefore, the test control unit 305 may initializes all of the six values in the management table 501 to zero.

Although the constant data 313 is not changed during the system test in FIG. 7, at least a part of the constant data 313 may be user defined. For example, the input device 205 may accept the input which specifies the constant data 313 from a user, and the test control unit 305 may set the input value as the constant data 313, and may store the constant data 313 in the RAM 202. Otherwise, the test control unit 305 may read the file of the constant data 313 from the ROM 203, the storage device 207, or the storage medium 210 to the RAM 202.

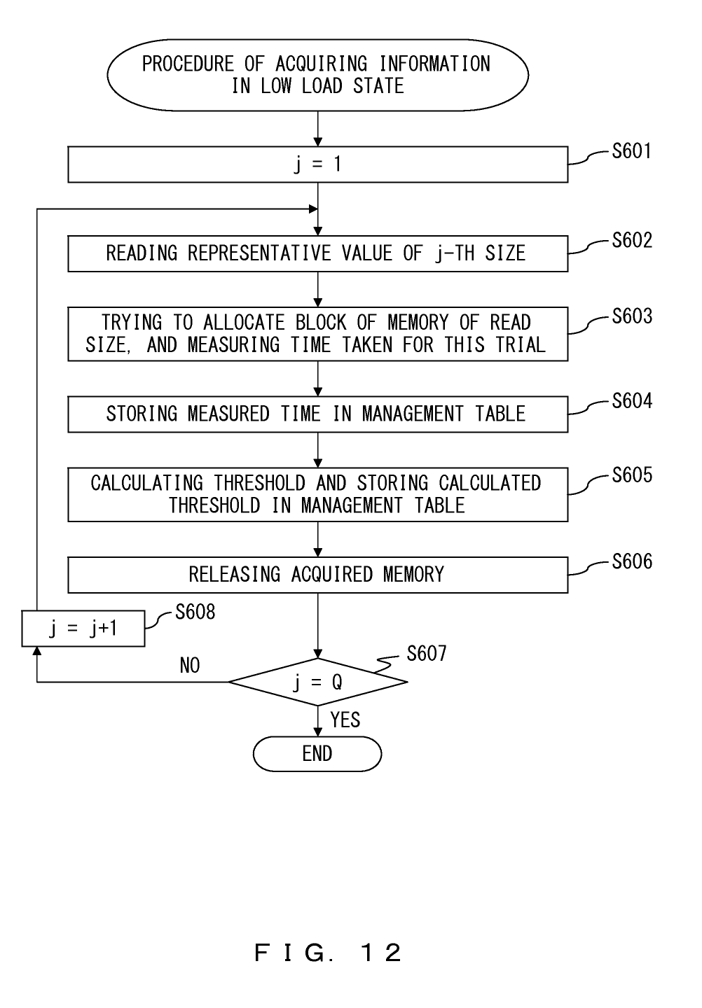

Next, in step S202, the test control unit 305 instructs the information acquisition unit 310 to perform the procedure of acquiring the information in the low load state. Concretely, the information acquisition unit 310 operates according to the flowchart in FIG. 8 in the second embodiment, and operates according to the flowchart in FIG. 12 in the third embodiment. In any embodiment, the information acquisition unit 310 acquires various types of information when the load of the entire computer 300 is low, and sets various values in the management table 312 using the acquired information.

Then, in step S203, the test control unit 305 determines the devices to be tested and the test condition depending on the configuration of the hardware 303. The details of step S203 is optional.

For example, when the hardware 303 includes four CPUs 201, the test control unit 305 may determine all of the four CPUs 201 as the devices to be tested. Similarly, when the RAM 202 is distributed on two DIMMs (dual in-line memory modules), the test control unit 305 may determine two DIMMs as the devices to be tested.

Furthermore, when the hardware 303 includes a memory controller or an MMU, the test control unit 305 may determine the memory controller or MMU as a device to be tested. When the hardware 303 includes the communication interface 204, the test control unit 305 may determine the communication interface 204 as a device to be tested. Similarly, when the hardware 303 includes the storage device 207, the test control unit 305 may determine the storage device 207 as a device to be tested.

Furthermore, the test control unit 305 determines the test condition depending on the specification of the device to be tested etc. For example, when the CPU 201 of the computer 300 is a single core CPU, the test control unit 305 may determine to conduct a test by applying the condition for a single core CPU. The test control unit 305 may also determine the condition to be applied in conducting a test of the RAM 202.

When the device to be tested and the test condition are determined, control is passed to step S204. In step S204, the test control unit 305 selects an untested device from among the devices to be tested.

In the next step S205, the test control unit 305 instructs an appropriate test execution unit to conduct a test on the device selected in step S204.

Concretely, when the test control unit 305 selects the CPU 201 in step S204, it instructs the CPU test execution unit 306 to conduct the test. When the test control unit 305 selects the RAM 202 in step S204, it instructs the memory test execution unit 307 to conduct the test.

Otherwise, when the test control unit 305 selects the storage device 207 in step S204, it instructs the disk test execution unit 308 to conduct the test. Furthermore, when the test control unit 305 selects the communication interface 204 in step S204, it instructs the network test execution unit 309 to conduct the test.

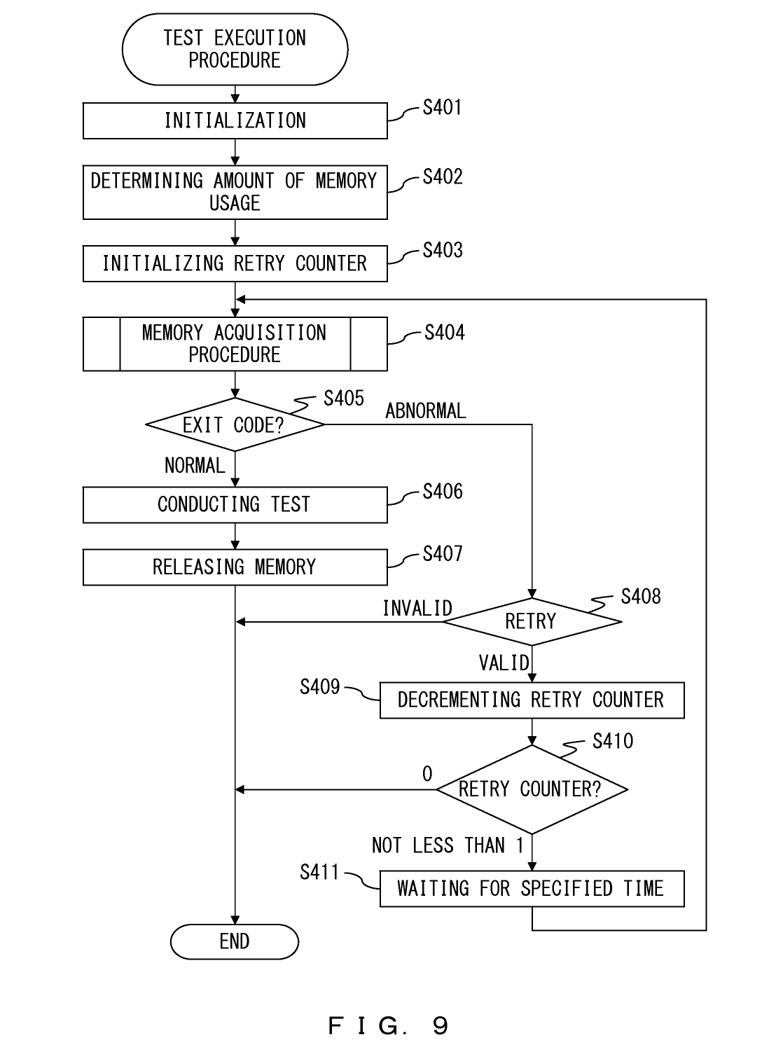

The CPU test execution unit 306, the memory test execution unit 307, the disk test execution unit 308, and the network test execution unit 309 conduct the test according to the flowchart in FIG. 9. After the test control unit 305 instructs an appropriate test execution unit to conduct the test, or after the test execution unit which has received an instruction has completed the execution of the test, control is passed to step S206.

If control is passed from step S205 to step S206 immediately after the test control unit 305 instructs an appropriate test execution unit to conduct the test, then the tests conducted by a plurality of test execution units are concurrently performed. On the other hand, if control is passed from step S205 to step S206 after completing the explanation of the test by the test execution unit which has received an instruction from the test control unit 305, then the tests conducted by a plurality of test execution units are performed in order one by one.

In step S206, the test control unit 305 judges whether or not all devices to be tested and determined in step S203 have been selected. If any unselected device to be tested remains, control is returned to step S204. On the other hand, if all devices to be tested have been selected, the system test in FIG. 7 is terminated.

FIG. 8 is a flowchart of a procedure of acquiring information in a low load state according to the second embodiment. The procedure in FIG. 8 is invoked from step S202 in FIG. 7.

For convenience of explanation below, it is assumed that a system test is not conducted during the execution of another user application. Then, the load of the computer 300 at the execution in step S202 is low. Therefore, by the procedure in FIG. 8 the information acquisition unit 310 may acquire various types of information when the load of the computer 300 is low.

In step S301, the information acquisition unit 310 invokes the memory usage amount measurement unit 315 and the time measurement unit 316, and recognizes the time taken to acquire the value indicating the memory usage state. The details of step S301 may be the following procedures 7-1 through 7-4.

(7-1) The time measurement unit 316 acquires the current time.

(7-2) The memory usage amount measurement unit 315 measures the amount of memory usage.

(7-3) When the memory usage amount measurement unit 315 completes the measurement of the procedure 7-2, the time measurement unit 316 acquires the current time again.

(7-4) By the time measurement unit 316 subtracting the time acquired in procedure 7-1 from the time acquired in procedure 7-3, the time measurement unit 316 measures the time taken to perform the measurement in the procedure 7-2 and returns the measured time to the information acquisition unit 310.

Then, in step S302, the information acquisition unit 310 stores the time measured in step S301 (that is, the time acquired from the time measurement unit 316 in the procedure 7-4) as the reference value REF_MEM in the management table 501.

Furthermore, in the next step S303, the information acquisition unit 310 refers to the constant data 502, reads the coefficient CO_MEM, and calculates the threshold TH_MEM by formula (9). Then, the information acquisition unit 310 stores the calculated threshold TH_MEM in the management table 501.

Next, in step S304, the information acquisition unit 310 invokes the CPU load measurement unit 314 and the time measurement unit 316, and recognizes the time taken to acquire the value indicating the CPU load state. The details in step S304 may be those in the following procedures 8-1 through 8-4.

(8-1) The time measurement unit 316 acquires the current time.

(8-2) The CPU load measurement unit 314 measures the amount of CPU usage (for example, expressed as the percentage of CPU usage).

(8-3) When the CPU load measurement unit 314 completes the measurement of the procedure 8-2, the time measurement unit 316 acquires the current time again.

(8-4) By the time measurement unit 316 subtracting the time acquired in the procedure 8-1 from the time acquired in the procedure 8-3, the time measurement unit 316 measures the time taken to perform the measurement in the procedure 8-2, and returns the measured time to the information acquisition unit 310.

Then, in step S305, the information acquisition unit 310 stores the time measured in step S304 (that is, the time obtained by the time measurement unit 316 in the procedure 8-4) as the reference value REF_CPU in the management table 501.

In the next step S306, the information acquisition unit 310 refers to the constant data 502, reads the coefficient CO_CPU, and calculates the threshold TH_CPU by formula (10). Then, the information acquisition unit 310 stores the calculated threshold TH_CPU in the management table 501.

Next, in step S307, the information acquisition unit 310 invokes the memory acquisition and release unit 317 and the time measurement unit 316, and thereby recognizes the time taken to try to allocate a block of a specified size of the memory. The details in step S307 may be those in the following procedures 9-1 through 9-6.

(9-1) The information acquisition unit 310 refers to the constant data 502 and recognizes the memory size SZ.

(9-2) The time measurement unit 316 acquires the current time.

(9-3) The information acquisition unit 310 requests the memory acquisition and release unit 317 to allocate a block of memory of the recognized size SZ.

(9-4) The memory acquisition and release unit 317 tries the allocation of memory of the requested size SZ, and returns a result of the trial (for example, returns a pointer) to the information acquisition unit 310.

(9-5) When the memory acquisition and release unit 317 completes the trial in the procedure 9-4, the time measurement unit 316 acquires the current time again.

(9-6) By the time measurement unit 316 subtracting the time acquired in the procedure 9-2 from the time acquired in the procedure 9-5, the time measurement unit 316 measures the time taken to try the memory allocation in the procedure 9-4, and returns the measured time to the information acquisition unit 310.

Next, in step S308, the information acquisition unit 310 stores the time measured in step S307 (that is, the time obtained by the time measurement unit 316 in the procedure 9-6) as the reference value REF_ALLOC in the management table 501.

In the next step S309, the information acquisition unit 310 refers to the constant data 502, reads the coefficient CO_ALLOC, and calculates the threshold TH_ALLOC by formula (11). Then, the information acquisition unit 310 stores the calculated threshold TH_ALLOC in the management table 501.

Finally, in step S310, the information acquisition unit 310 invokes the memory acquisition and release unit 317 to release (i.e., to free) the block of the memory acquired in step S307. Then, the memory acquisition and release unit 317 releases the block of the memory.

As described above, the value corresponding to the condition of the computer 300 is set in the management table 501 by the procedure in FIG. 8. For convenience of explanation below, it is assumed in the procedure in FIG. 8 that the memory allocation has succeeded in step S307 because the procedure in FIG. 8 is executed when the computer 300 is in a low load state, and memory allocation succeeds in most cases. However, depending on the embodiment, error processing to be performed when memory allocation fails may be further performed.

Described below is the test execution procedure invoked in step S205 in FIG. 7. FIG. 9 is a flowchart of a test execution procedure common between the second and third embodiments.

As described above with reference to step S205, the procedure in FIG. 9 is performed by the CPU test execution unit 306, the memory test execution unit 307, the disk test execution unit 308, or the network test execution unit 309 depending on the device selected in step S204. For convenience of explanation below, the common operation among the test execution units may be expressed simply as a test execution unit such as “a test execution unit performs initialization” etc.

In step S401, the test execution unit performs initialization. For example, at an instruction from the test control unit 305 or from a user through the input device 205, the test execution unit performs initialization (for example, initialization of a parameter) depending on the test contents, test method, test condition, etc.

Then, in the next step S402, the test execution unit determines the amount of memory usage (more concretely, the size of a memory area dynamically requested for allocation). The amount of memory usage is determined, for example, depending on the test condition determined by the test control unit 305 in step S203 in FIG. 7.

For example, the memory test execution unit 307 uses memory for testing memory (concretely the RAM 202). Furthermore, the CPU test execution unit 306 may request the allocation of a memory area on the RAM 202 to, for example, test the cache memory in the CPU 201, or to temporarily store a result of a calculation by the CPU 201.

Furthermore, the disk test execution unit 308 may request the allocation of a memory area on the RAM 202 to, for example, test the throughput of data transfer between the storage device 207 and the RAM 202. The network test execution unit 309 may also request the allocation of a memory area on the RAM 202 for use as a transmission buffer or a reception buffer in the test of the communication interface 204.

As described above, in step S402, the test execution unit appropriately determines the amount of memory usage.

Next, in step S403, the test execution unit reads the initial value RT_CNT of the retry counter in the constant data 313, and sets the initial value RT_CNT in the retry counter. For example, the initial value RT_CNT may be a relatively small number such as 2 through 5.

Next, in step S404, the test execution unit specifies an amount of memory usage determined in step S402 and invokes the memory acquisition unit 311. Then, the memory acquisition unit 311 performs a memory acquisition procedure.

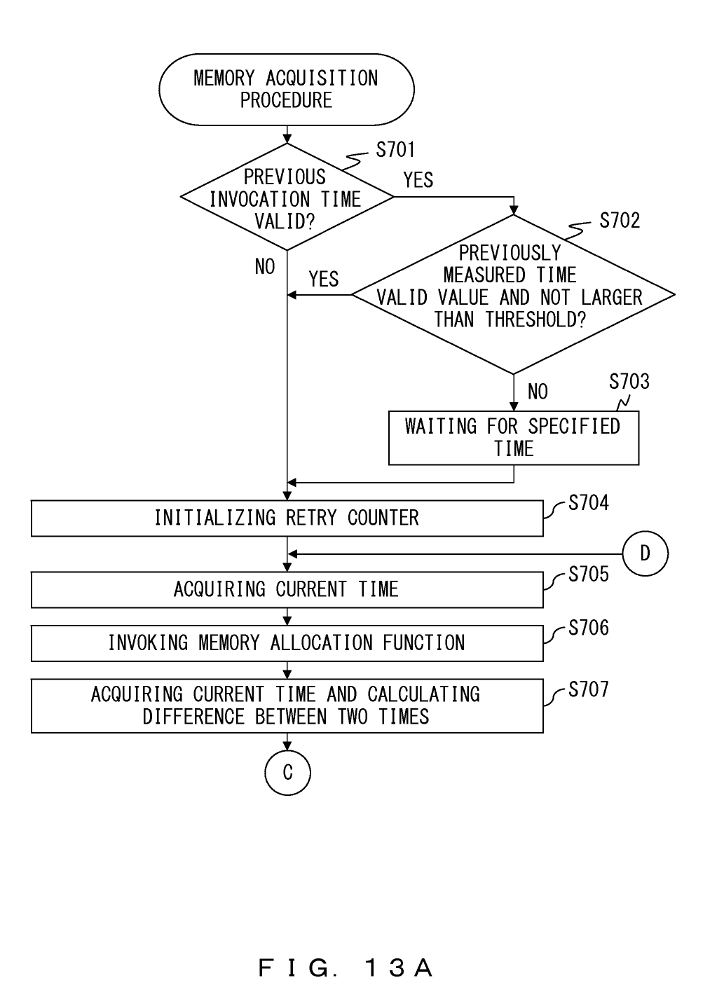

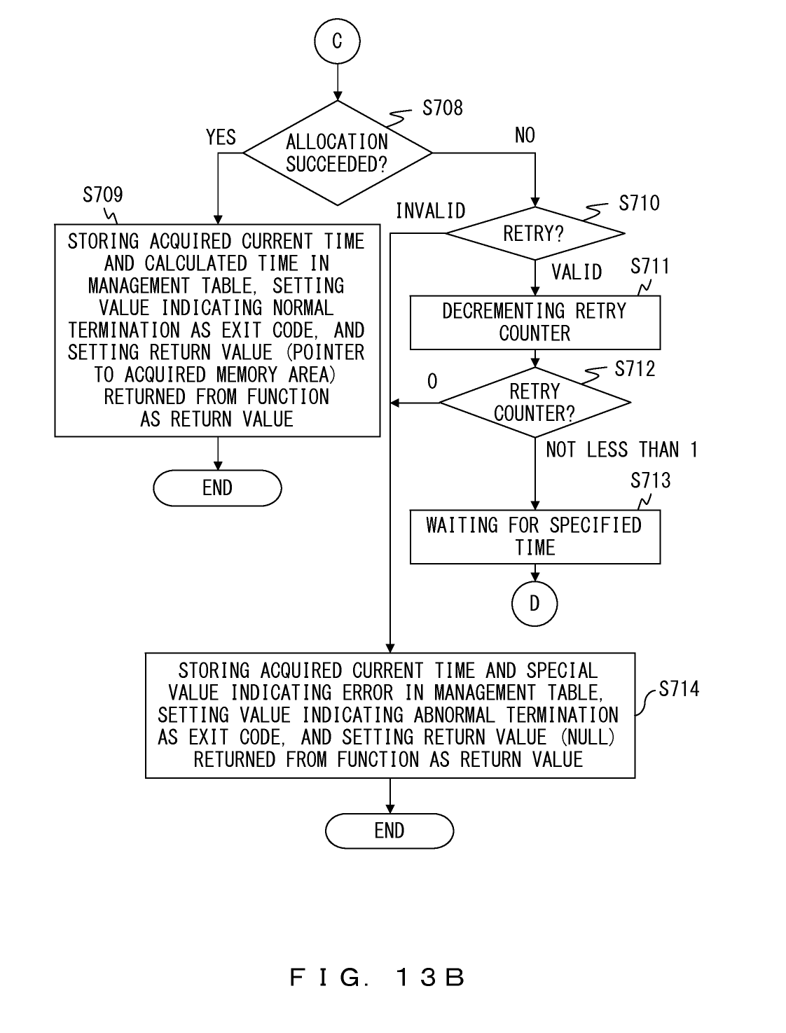

Concretely, in the second embodiment, the memory acquisition unit 311 performs the memory acquisition procedure according to the flowchart in FIGS. 10A and 10B. In the third embodiment, the memory acquisition unit 311 performs the memory acquisition procedure according to the flowchart in FIGS. 13A and 13B.

For convenience of explanation below, in the second and third embodiments, a result of the memory acquisition processing in step S404 is described in the procedures 10-1 and 10-2 below. An exit code may be expressed as, for example, a specified variable such as “errno” defined in the library.

(10-1) If memory allocation succeeds (that is, the memory in size determined in step S402 is successfully acquired), the value indicating a normal termination is set as an exit code, and a pointer which points to the leading address of an acquired memory area is returned to the test execution unit

(10-2) If memory allocation fails, the value indicating an abnormal termination is set as an exit code, and a NULL pointer is returned to the test execution unit.

After the memory acquisition processing in step S404, the test execution unit judges in step S405 which the exit code refers to, normal or abnormal. If the exit code refers to a normal termination, control is passed to step S406. On the other hand, if the exit code refers to an abnormal termination, control is passed to step S408.

In step S406, the test execution unit conducts an appropriate test using successfully allocated memory.

For example, the CPU test execution unit 306 tests a processor core in the CPU 201 and cache memory. Furthermore, the memory test execution unit 307 tests the DIMM loaded with a chip of the RAM 202, the memory controller, the MMU, the memory bus, etc. by performing a reading operation and a writing operation on the memory (concretely the RAM 202).

The disk test execution unit 308 tests the magnetic disk medium of the HDD, the HDD controller, the I/O bus, etc. by performing a reading operation and a writing operation on the storage device 207 (concretely the HDD for example). Furthermore, the network test execution unit 309 transmits data to the network 211 using the communication interface 204, and receives data from the network 211 using the communication interface 204. Thus, the network test execution unit 309 tests a network controller and a network transmission line.

After the termination of the test, the test execution unit requests the memory acquisition and release unit 317 in step S407 to release the memory acquired in step S404. Then, the test execution procedure in FIG. 9 also terminates.

On the other hand, when memory is not acquired in step S404, the test execution unit reads the value of the retry flag RT_FLAG in the constant data 313 in step S408. Then, if the retry flag RT_FLAG indicates that the retry is valid, control is passed to step S409. On the other hand, if the retry flag RT_FLAG indicates that the retry is invalid, then the test execution procedure in FIG. 9 terminates.

In step S409, the test execution unit decrements the retry counter. Then, in step S410, the test execution unit judges whether or not the value of the retry counter is zero.

If the value of the retry counter is zero, the test execution procedure in FIG. 9 terminates. On the other hand, when the value of the retry counter is not less than 1, control is passed to step S411.

In step S411, the test execution unit reads the value of the retry wait time RT_WAIT in the constant data 313. Then, the test execution unit waits for the retry wait time RT_WAIT. When the retry wait time RT_WAIT passes, control is returned to step S404.

If memory allocation is tried again immediately after the failure in the memory allocation, the state of the computer 300 is little changed. Therefore, there is a strong possibility that the memory allocation fails again. Then, to enhance the likelihood of success in memory allocation by the retry, the test execution unit waits for the specified wait time RT_WAIT as in step S411.

Described next is the memory acquisition procedure invoked from step S404 in FIG. 9 in the second embodiment. FIGS. 10A and 10B illustrate a flowchart of a memory acquisition procedure according to the second embodiment.

In step S501, the memory acquisition unit 311 invokes the memory usage amount measurement unit 315 and the time measurement unit 316, and recognizes the time taken to acquire the value indicating the memory usage state. The details of step S501 may be similar to those of step S301. That is, simultaneously when the memory usage amount measurement unit 315 acquires the value u_mem indicating the memory usage state, the time measurement unit 316 measures the time taken to perform the acquisition (that is, the measurement time t_mem in FIG. 5).

Step S501 is different from step S301 in that the measured time t_mem is returned from the time measurement unit 316 to the memory acquisition unit 311. In step S501, the memory usage amount measurement unit 315 notifies the memory acquisition unit 311 of the measured amount of memory usage (that is, the amount of usage u_mem in FIG. 5).

Then, in step S502, the memory acquisition unit 311 invokes the CPU load measurement unit 314 and the time measurement unit 316, and recognizes the time taken to acquire the value indicating the CPU load state. The details of step S502 may be, for example, similar to those of step S304 in FIG. 8. That is, simultaneously when the CPU load measurement unit 314 acquires the value u_cpu indicating the CPU load state, the time measurement unit 316 measures the time taken to perform the acquisition (that is, the measurement time t_cpu in FIG. 5).

Step S502 is different from step S304 in that the measured time t_cpu is returned from the time measurement unit 316 to the memory acquisition unit 311. In step S502, the CPU load measurement unit 314 notifies the memory acquisition unit 311 of the measured amount of CPU usage (that is, the amount of usage u_cpu in FIG. 5).

Then, in step S503, the memory acquisition unit 311 judges whether or not the lengths of two times recognized in steps S501 and S502 are out of reference. That is, the memory acquisition unit 311 reads the threshold TH_MEM and TH_CPU from the management table 501, and judges whether or not the formula (12) holds.

(TH_MEM<t_mem) [symbol] (TH_CPU<t_cpu)=true (12)

As illustrated in FIG. 5, in any of the cases 1 through 4 in FIG. 5, formula (12) holds, and in the cases 5 through 16, formula (12) does not hold. When formula (12) holds, control is passed to step S504. On the other hand, when formula (12) does not hold, control is passed to step S505.

In step S504, the memory acquisition unit 311 sets the value indicating an abnormal termination as an exit code, and sets the NULL pointer as a return value to the test execution unit. Then, the memory acquisition procedure terminates

In step S505, the memory acquisition unit 311 judges whether or not both the amount of memory usage and the CPU load are large. That is, the memory acquisition unit 311 reads the judgment thresholds HI_MEM and HI_CPU in the constant data 502, and judges whether or not formula (13) holds.

(HI_MEM<u_mem) [symbol] (HI_CPU<u_cpu)=true (13)

In step S505, the judgment is obtained in any of the cases 5 through 16 in FIG. 5. Then, in the cases 5 through 16, formula (13) holds in the case 5, 9, or 13 as illustrated in FIG. 5.

When formula (13) holds, control is passed to step S504. On the other hand, when formula (13) does not hold, control is passed to step S506.

Steps S503 and S505 correspond to step S102 in FIG. 1. The transition from step S503 or S505 to step S504 corresponds to the transition from step S102 to step S106. Furthermore, step S504 corresponds to step S106.

As clearly known from the correspondence described above, the acceptance of the request in step S101 in FIG. 1 corresponds to the invocation of the procedure in FIGS. 10A and 10B from step S404 in FIG. 9. That is, in the second embodiment, the memory acquisition unit 311 accepts the request for memory allocation in step S101 from the test execution unit.

When formula (13) does not hold, the memory acquisition unit 311 reads the initial value RT_CNT of the retry counter in the constant data 502 in step S506, and sets the initial value RT_CNT in the retry counter. For example, the initial value RT_CNT may be a relatively small number such as 2 through 5.

In the second embodiment, the same initial value RT_CNT is used in step S403 in FIG. 9 and in step S506 in FIG. 10A. However, in some embodiments, the initial value for step S403 and the initial value for step S506 may be separately defined in the constant data 502.

Then, the memory acquisition unit 311 invokes the memory acquisition and release unit 317 and the time measurement unit 316 in step S507. Concretely, the memory acquisition unit 311 instructs the memory acquisition and release unit 317 to try to allocate a block of the memory (more specifically, a block of the size specified by the test execution unit), and instructs the time measurement unit 316 to measure the time taken for this trial.

The invocation of the memory acquisition and release unit 317 from the memory acquisition unit 311 may concretely be realized by the invocation of the library function for memory allocation such as malloc ( ) etc. The time measured by the time measurement unit 316 is, in other words, a length of time taken from the point in time at which the library function is invoked from an application to the point in time at which a return value is returned from the library function to the application.

Then, after the memory acquisition and release unit 317 tries memory allocation in step S507, the memory acquisition unit 311 judges in step S508 whether or not the memory allocation has succeeded.

For example, when the memory acquisition and release unit 317 succeeds in memory allocation, the memory acquisition and release unit 317 returns a pointer which points to the head of the allocated memory area to the memory acquisition unit 311, and may set the value indicating a normal termination as an exit code. If the memory acquisition and release unit 317 fails in memory allocation, the memory acquisition and release unit 317 may also return the NULL pointer to the memory acquisition unit 311 and set the value indicating an abnormal termination as an exit code. Therefore, the memory acquisition unit 311 may judge whether or not memory allocation has succeeded using a return value from the memory acquisition and release unit 317, an exit code, or both of them in step S508.

Then, if memory allocation succeeds in step S507, control is passed from step S508 to step S509. On the other hand, if memory allocation fails in step S507, control is passed from step S508 to step S510.

In step S509, the memory acquisition unit 311 sets the value indicating a normal termination as an exit code. The memory acquisition unit 311 sets the return value returned from the memory acquisition and release unit 317 (that is, the pointer which points to the memory area acquired by the memory acquisition and release unit 317) as a return value to the test execution unit. Then, the memory acquisition procedure terminates.

When memory allocation fails, the memory acquisition unit 311 reads the threshold TH_ALLOC from the management table 501 in step S510, and compares the time measured by the time measurement unit 316 with the threshold TH_ALLOC in step S507. If the measured time is not more than the threshold TH_ALLOC, then control is passed to step S511 in order to judge whether or not there is room for retry.

On the other hand, when the measured time is longer than the threshold TH_ALLOC, the memory acquisition unit 311 judges that there is no room for retry. Then, control is passed to step S515.

When the measured time is longer than the threshold TH_ALLOC, it means that not only memory allocation fails, but also it takes a long time just to know that the memory allocation has failed. It is inferred that the reason why it takes a long time just to know a failure is that the load of the entire computer 300 is considerably heavy.

When the load of the computer 300 is considerably high, there is a strong possibility of failure even if the memory acquisition and release unit 317 may try memory allocation again. Therefore, when the time measured in step S507 is longer than the threshold TH_ALLOC, the memory acquisition unit 311 judges that there is no room for retry.

In step S511, the memory acquisition unit 311 reads the value of the retry flag RT_FLAG in the constant data 502. If the retry flag RT_FLAG indicates that retry is valid, control is passed to step S512. On the other hand, if the retry flag RT_FLAG indicates that retry is invalid, control is passed to step S515.

In step S512, the memory acquisition unit 311 decrements the retry counter. In the next step S513, the memory acquisition unit 311 judges whether or not the value of the retry counter is zero.

When the value of the retry counter is zero, control is passed to step S515. On the other hand, when the value of the retry counter is not less than 1, control is passed to step S514.

In step S514, the memory acquisition unit 311 reads the value of the retry wait time RT_WAIT in the constant data 313. Then, the memory acquisition unit 311 waits for the retry wait time RT_WAIT. When the retry wait time RT_WAIT passes, control is returned to step S507.

The reason why the memory acquisition unit 311 waits for the specified time RT_WAIT in step S514 is similar to the reason described above with reference to step S411 in FIG. 9.

In the second embodiment, the same retry flag RT_FLAG is referred to in step S408 in FIG. 9 and step S511 in FIG. 10B. However, in some embodiments, the retry flags for steps S408 and S511 may be separately defined in the constant data 502. Similarly, in the constant data 502, the retry wait time for steps S411 and S514 may be separately defined.

When it is judged in step S510, S511, or S513 that there is no room for retry, the memory acquisition unit 311 operates in step S515 as follows. That is, the memory acquisition unit 311 sets the value indicating an abnormal termination as an exit code. In addition, the memory acquisition unit 311 sets the return value of the library function for memory allocation (that is, the NULL pointer as a return value from the memory acquisition and release unit 317) as a return value to the test execution unit. Then, the memory acquisition procedure terminates.

The trial of memory allocation by the invocation of the memory acquisition and release unit 317 in step S507 in FIG. 10A corresponds to step S103 in FIG. 1. Steps S509 and S515 in FIG. 10B correspond to step S104 in FIG. 1.

From a certain point of view, the procedure in the flowchart F2 in FIG. 1 is an example of the case in which no retry is performed in the procedure in FIGS. 10A and 10B (for example, invalid retry by the retry flag RT_FLAG, or the initial value RT_CNT of the retry counter of 1). From another point of view, the procedure in FIGS. 10A and 10B is a procedure obtained by adding retry control between steps S103 and S104 in the flowchart F2 in FIG. 1.

In the second embodiment described above, although memory allocation is requested, memory allocation is not tried in a heavy load state in which there is a strong likelihood that the trial of the memory allocation fails. Therefore, the problems such as reduced efficiency, stall, hang, etc. caused by a trial of memory allocation in a heavy load state are reduced. Therefore, according to the second embodiment, a system test is conducted efficiently in order.

The third embodiment is described below with reference to FIGS. 11 through 13B. Also in the third embodiment, the computer 300 in FIG. 4 is used. The hardware configuration of the computer 300 may be, for example, the configuration illustrated in FIG. 3.

In the third embodiment, concretely a management table 601 and a constant data 602 in FIG. 11, not the management table 501 or the constant data 502 in FIG. 6, are used as the management table 312 and the constant data 313 in FIG. 4.

The operations of the information acquisition unit 310 and the memory acquisition unit 311 are different between the second and third embodiments. That is, the procedures in the flowcharts in FIGS. 8, 10A, and 10B are replaced with the procedures of the flowcharts in FIGS. 12, 13A, and 13B in the third embodiment.

Other points are similar to those in the second embodiment. Therefore, in the description below, the explanation of the common points with the second embodiment are omitted.

FIG. 11 illustrates data used in the third embodiment. The management table 601 in FIG. 11 includes, for each of a plurality of memory sizes, the reference value and threshold of the time relating to the trial of memory allocation, the time measured in the previous actual trial, and the latest invocation time of the library function for the memory allocation.

Although the number of memory sizes may be arbitrarily determined, the number of memory sizes is 4 for convenience of explanation in the third embodiment. The size number 1 refers to the size not more than 4 KB. For example, when the page size prescribed by the OS 302 is 4 KB, the size not more than the page size may be defined as the smallest size.

The size number 2 refers to the size larger than 4 KB and not more than 400 KB. The size number 3 refers to the size larger than 400 KB and not more than 40 MB (megabytes). The size number 4 refers to the size larger than 40 MB.

The management table 601 includes, for each size number j (1≦j≦4), the reference value REFj and the threshold THj relating to the time taken to try to allocate a block of the memory of the j-th size. The management table 601 also includes, for each size number j (1≦j≦4), the time PREVj taken to previously try the allocation of a block of the memory of the j-th size, and the time LTj at which the library function is invoked for the previous trial of the memory allocation.

In the example in FIG. 11, the unit of the reference value REFj, the threshold THj, and the actually measured time PREVj is μs (microsecond). Furthermore, the latest invocation time LTj may also be expressed in the accuracy of ms (millisecond) unit, for example, in the format of “yyyy/mm/dd hh:mm:ss.sss”, or may be expressed in other type of accuracy.

The above-mentioned management table 601 may be initialized as follows in step S201 in FIG. 7. The reference value REFj, the threshold THj, and the previously measured time PREVj may be initialized to zero. Furthermore, the latest invocation time LTj may be initialized to a special value invalid as time (for example, a value having all bits set to 0).

The constant data 602 also includes, as with the constant data 502 in FIG. 6, the retry validity flag RT_FLAG, the retry wait time RT_WAIT, and the initial value RT_CNT of a retry counter.

The constant data 602 includes the coefficient CO_ALLOC relating to the time taken to try memory allocation as with the constant data 502. However, the third embodiment is different from the second embodiment in the usage of the coefficient CO_ALLOC. As described later in detail with reference to FIG. 12, the threshold THj in the management table 601 is calculated from the reference value REFj by formulas (14) through (17).

TH1=REF1×CO_ALLOC (14)

TH2=REF2×CO_ALLOC (15)

TH3=REF3×CO_ALLOC (16)

TH4=REF4×CO_ALLOC (17)

As described later in detail with reference to FIGS. 13A and 13B, the time PREVj having been measured in the previous try at memory allocation may be compared with the threshold THj in the third embodiment. However, the comparison performed using very old data may incur inappropriate judgment. Therefore, the valid duration VALID_DUR from the previous invocation of the library function for memory allocation is also defined. The duration VALID_DUR indicates the length of time.

Furthermore, the constant data 602 includes the representative value SZj of the j-th memory size for each size number j (1≦j≦4). For example, in the example in FIG. 11, the representative value SZ1 of the first memory size is 4 KB as the upper limit of the first memory size.

Similarly, the representative value SZ2 of the second memory size is 400 KB as the upper limit of the second memory size, and the representative value SZ3 of the third memory size is 40 MB as the upper limit of the third memory size. The representative value SZ4 of the fourth memory size is, for example, 4 GB (gigabyte).

The operation of the computer 300 according to the third embodiment is described below further in detail with reference to the flowcharts in FIGS. 12, 13A, and 13B. As described above, the flowcharts in FIGS. 7 and 9 are common between the second and third embodiments. The third embodiment is different from the second embodiment in that the procedure in FIG. 12, not the procedure in FIG. 8, is invoked from step S202 in FIG. 7, and the procedure in FIGS. 13A and 13B, not the procedure in FIGS. 10A and 10B, is invoked from step S404 in FIG. 9.

FIG. 12 is a flowchart of a procedure of acquiring information in a low load state according to the third embodiment. The procedure in FIG. 12 is invoked from step S202.

For convenience of explanation below, it is assumed that the system test is not conducted during the execution of another user application. Then, the load of the computer 300 at the run time in step S202 is low. Therefore, by the procedure in FIG. 12, the information acquisition unit 310 may acquire various types of information when the load of the computer 300 is low.

Furthermore, for convenience of explanation below, it is assumed, as with the assumption with reference to FIG. 8, that the trial of memory allocation will succeed in the procedure in FIG. 12. However, in some embodiments, it is obvious that an error handling procedure may be further performed in case memory allocation fails.

In step S601, the information acquisition unit 310 initializes the index variable j indicating the size number of the management table 601 to 1.

Then, in the next step S602, the information acquisition unit 310 refers to the constant data 602, and reads the representative value SZj of the j-th memory size.

Then, in step S603, the information acquisition unit 310 invokes the memory acquisition and release unit 317 and the time measurement unit 316. Concretely, the memory acquisition unit 311 instructs the memory acquisition and release unit 317 to try to allocate a block of the memory of the read representative value SZj, and instructs the time measurement unit 316 to measure the time taken for this trial. The details of step S603 are similar to those in step S307 in FIG. 8 except the requested memory size.

Next, in step S604, the information acquisition unit 310 stores the time measured in step S603 as the reference value REFj of the measurement time of the j-th memory size in the management table 601.

In the next step S605, the information acquisition unit 310 refers to the constant data 602, reads the coefficient CO_ALLOC, and calculates the threshold THj by any of formulas (14) through (17). Then, the information acquisition unit 310 stores the calculated threshold THj in the management table 601.

Then, in step S606, the information acquisition unit 310 invokes the memory acquisition and release unit 317 to release the memory acquired in step S603. Then, the memory acquisition and release unit 317 releases the memory.

Then, in step S607, the information acquisition unit 310 judges whether or not the value of the index variable j has reached the number of memory sizes (for convenience of explanation below, the number is expressed as “Q”) defined in the management table 601 in FIG. 11. In the example in FIG. 11, Q equals 4 (Q=4).

If j=Q, the procedure in FIG. 12 terminates. On the other hand, if j<Q, control is passed to step S608.

In step S608, the information acquisition unit 310 increments the variable j by 1. Then, control is returned to step S602.

As described above, by the procedure in FIG. 12, for j which satisfies 1≦j≦Q, the reference value REFj and the threshold THj are set in the management table 601.

Described below is the memory acquisition procedure invoked from step S404 in FIG. 9 in the third embodiment. FIGS. 13A and 13B illustrate a flowchart of a memory acquisition procedure according to the third embodiment. In step S404, the allocation of the memory of the size determined by the test execution unit in step S402 is requested. For convenience of explanation below, the size of the requested memory is expressed as “sz-req”.

In step S701, the memory acquisition unit 311 judges whether or not the previous invocation time LTj (1≦j≦Q) corresponding to the memory size sz_req requested from the test execution unit is valid.

For example, assume that the requested memory size sz_req is 100 KB. In this case, according to the management table 601 in FIG. 11, the requested memory size sz_req is included in the range of the size number 2. Therefore, the memory acquisition unit 311 reads the previous invocation time LT2 from the management table 601.

Then, the memory acquisition unit 311 judges whether or not the read time LTj (j=2 in the above-mentioned example of sz_req=100 KB) is valid. In the following explanation relating to FIGS. 13A and 13B, the subscript j indicates the “size number” of the memory size corresponding to the requested memory size sz_req.

As explained above with reference to FIG. 11, the latest invocation time LTj is initialized to a special value (for example, the value whose bits are all reset to 0) which is invalid as a time. Therefore, when the test execution unit first requests the allocation of the memory of the j-th size, the time LTj read by the memory acquisition unit 311 is set to a special value which is invalid as time. When the time LTj is set to a special value which is invalid as a time, it is obvious that the time LTj is invalid.

Furthermore, even when the time LTj is set to a value which is significant as a time, the time LTj is invalid if the time LTj is very old. Therefore, when the time LTj is set as a significant value as time, the memory acquisition unit 311 reads the duration VALID_DUR from the constant data 602, and acquires the current time. For example, the memory acquisition unit 311 may acquire the current time by the time acquisition function of the time measurement unit 316 by invoking the time measurement unit 316.

Then, the memory acquisition unit 311 calculates the difference between the current time and the time LTj, and compares the calculated difference with the duration VALID_DUR.

If the difference exceeds the duration VALID_DUR, the memory acquisition unit 311 judges that the time LTj is invalid time (that is, an old time). On the other hand, if the difference is in the range of the duration VALID_DUR, the memory acquisition unit 311 judges that the time LTj is a valid time (that is, a new time).

When the time LTj is valid (that is, the time LTj is significant as time, and a new valid time), control is passed to step S702 to make a judgment using the previously measured time PREVj. On the other hand, if the time LTj is invalid (that is, the time LTj is set to a special value which is insignificant as time, or the time LTj is an invalid old time), control is passed to step S704 to try memory allocation.

In step S702, the memory acquisition unit 311 judges whether or not the condition that the previously measured time PREVj is valid as the length of time and is not more than the threshold THj.

As explained with reference to FIG. 11, the previously measured time PREVj is the time taken to perform the trial when the allocation of memory of a certain size included within the range of the size number j is tried at the time LTj. That is, the previously measured time PREVj is the time taken to perform the “specific procedure” according to the third embodiment.

That is, the memory acquisition unit 311 in step S702 makes a judgment similar to that in step S102 in FIG. 1. Concretely, the memory acquisition unit 311 first judges whether or not the previously measured time PREVj is set to an effective value as a length of time.

As described later, the previously measured time PREVj is set to an invalid value if the allocation has not succeeded in spite of as many number of tries at memory allocation as the initial value RT_CNT of the retry counter performed in response to the previous request for allocation of a block of the memory of the j-th memory size. Therefore, the memory acquisition unit 311 first judges whether or not the previously measured time PREVj is set to a valid value as a length of time.

If the previously measured time PREVj is set to a valid value as a length of time, then the memory acquisition unit 311 judges whether the previously measured time PREVj is not more than the threshold THj corresponding to the same memory size.

If the previously measured time PREVj is valid as a length of time, and is not more than the threshold THj, then there is a strong likelihood that the trial of the memory allocation will succeed. This is because, in this case, the previously measured time PREVj indicates the fact that the trial of the memory allocation performed lately within the duration VALID_DUR has been completed within a relatively short time which is not more than the threshold THj. From the fact, it is considered that the load of the computer 300 is not outstandingly heavy lately. Therefore, control is passed to step S704.

On the other hand, if the previously measured time PREVj is set to an invalid value as a length of time, or is longer than the threshold THj, then there is a strong likelihood that the trial of memory allocation will fail. This is because the previously measured time PREVj set to an invalid value as a length of time indicates the fact that the trial of the memory allocation performed lately within the duration VALID_DUR has finally failed although the retrial has been performed. The previously measured time PREVj longer than the threshold THj indicates the fact that the trial of the memory allocation performed lately within the duration VALID_DUR has finally succeeded, but it has taken a long time. From the facts, it is considered that the load of the computer 300 is considerably heavy lately, and therefore the trial will probability fail if the memory allocation is tried immediately. Therefore, control is passed to step S703.

In step S703, the memory acquisition unit 311 waits for a specified time. Concretely, the memory acquisition unit 311 reads the value of the retry wait time RT_WAIT in the constant data 602, and the memory acquisition unit 311 waits for the retry wait time RT_WAIT. If the retry wait time RT_WAIT has passed, control is passed to step S704.

As understood from the explanation above, steps S701 and S702 correspond to step S102 in FIG. 1. That is, the specific procedure in the third embodiment is a trial of the memory allocation performed within the duration VALID_DUR, and the judgment condition in the third embodiment is the condition C of formula (6).

Then, the transition from step S701 or S702 to step S704 corresponds to the transition from step S102 to step S103. Furthermore, step S703 corresponds to step S105. That is, the transition from step S702 to step S703 corresponds to the transition from step S102 to step S105.

Then, as clearly known from the above-mentioned correspondence, the acceptance of the request in step S101 in FIG. 1 corresponds to the invocation of the procedure in FIGS. 13A and 13B from step S404 in FIG. 9. That is, in the third embodiment, the memory acquisition unit 311 accepts a request for memory allocation in step S101 from a test execution unit.

In step S704, the memory acquisition unit 311 reads the initial value RT_CNT of the retry counter in the constant data 602, and set the initial value RT_CNT in the retry counter. For example, the initial value RT_CNT may be a relatively small number such as 2 through 5.

In the third embodiment, the same initial value RT_CNT is used in step S403 in FIG. 9, and step S704 in FIG. 13A. However, in some embodiments, the initial value for step S403 and the initial value for step S704 may be separately defined.

Next, in steps S705 through S707, the memory acquisition unit 311 instructs the memory acquisition and release unit 317 to try to allocate the memory of the size sz_req specified from the test execution unit, and the time measurement unit 316 to measure the time taken to perform the trial.

Concretely, first in step S705, in response to the invocation from the memory acquisition unit 311, the time measurement unit 316 acquires the current time. The time measurement unit 316 notifies the memory acquisition unit 311 of the acquired current time.

Next, in step S706, the memory acquisition unit 311 invokes the memory acquisition and release unit 317. The invocation of the memory acquisition and release unit 317 from the memory acquisition unit 311 may be concretely realized by the invocation of a library function for memory allocation such as malloc( ) etc. The invoked memory acquisition and release unit 317 tries the memory allocation for the memory size sz_req specified by the test execution unit.

Then, in step S707, the memory acquisition unit 311 invokes the time measurement unit 316, and acquires the current time again. The time measurement unit 316 also calculates the difference between two times acquired in steps S705 and S707, and notifies the memory acquisition unit 311 of the calculated difference.

Then, in step S708, the memory acquisition unit 311 judges whether or not the memory allocation in step S706 has succeeded.

For example, when the memory acquisition and release unit 317 succeeds memory allocation, it may return a pointer which points to the head of the allocated memory area to the memory acquisition unit 311, and set a value indicating a normal termination as an exit code. When the memory acquisition and release unit 317 fails the memory allocation, it may return a NULL pointer to the memory acquisition unit 311, and sets a value indicating an abnormal termination as an exit code. Therefore, the memory acquisition unit 311 may judge whether or not the memory allocation has succeeded by using the return value from the 317, the exit code, or both of them in step S708.

Then, if the memory allocation succeeds in step S706, the control is passed from step S708 to step S709. On the other hand, if the memory allocation fails in step S706, control is passed from step S708 to step S710.

In step S709, the memory acquisition unit 311 operates as follows.

That is, the memory acquisition unit 311 stores the current time acquired by the time measurement unit 316 in step S705 as the latest invocation time LTj in the management table 601. Furthermore, the memory acquisition unit 311 stores the time calculated by the time measurement unit 316 in step S707 as the previously measured time PREVj in the management table 601.

Furthermore, the memory acquisition unit 311 sets the value indicating the normal termination as an exit code. The memory acquisition unit 311 also sets the return value returned from the memory acquisition and release unit 317 (that is, a pointer which points to the memory area acquired by the memory acquisition and release unit 317) as a return value to the test execution unit. Then, the memory acquisition procedure terminates.

On the other hand, when the memory allocation fails, the memory acquisition unit 311 reads in step S710 the value of the retry flag RT_FLAG in the constant data 602. If the retry flag RT_FLAG indicates that the retry is valid, control is passed to step S711. On the other hand, if the retry flag RT_FLAG indicates that the retry is invalid, then control is passed to step S714.

In step S711, the memory acquisition unit 311 decrements the retry counter. In the next step S712, the memory acquisition unit 311 judges whether or not the value of the retry counter is zero.

If the value of the retry counter is zero, control is passed to step S714. On the other hand, if the value of the retry counter is not less than 1, control is passed to step S713.

In step S713, the memory acquisition unit 311 reads the value of the retry wait time RT_WAIT in the constant data 313. Then, the memory acquisition unit 311 waits for the retry wait time RT_WAIT. If the retry wait time RT_WAIT has passed, control is returned to step S705.

The reason why the memory acquisition unit 311 waits for the retry wait time RT_WAIT in steps S703 and S713 is similar to the reason explained above with reference to step S411 in FIG. 9.

Furthermore, in the third embodiment, in step S408 in FIG. 9 and step S710 in FIG. 13B, the same retry flag RT_FLAG is referred to. Then, in step S411 in FIG. 9, step S703 in FIG. 13A, and step S713 in FIG. 13B, the same retry wait time RT_WAIT is referred to.

However, in some embodiments, the retry flags for steps S408 and S710 may be separately defined in the constant data 602. Similarly, in the constant data 602, the wait time for step S411, the wait time for step S703, and the wait time for step S713 may be separately defined.

The memory acquisition unit 311 operates as follows in step S714 when it judges in step S710 or S712 that there is no room for the retry.

That is, the memory acquisition unit 311 stores the current time acquired by the time measurement unit 316 in step S705 as the latest invocation time LTj in the management table 601. The memory acquisition unit 311 stores the special value indicating an error (for example, the value whose bits are all set to 1) as the previously measured time PREVj in the management table 601. The special value is an invalid value as a length of time.

Furthermore, the memory acquisition unit 311 sets a value indicating an abnormal termination as an exit code. The memory acquisition unit 311 also sets a return value returned from a library function for memory allocation (that is, sets a NULL pointer as a return value from the memory acquisition and release unit 317) as a return value to the test execution unit. Then, the memory acquisition procedure terminates.

The trial of memory allocation by the invocation of the memory acquisition and release unit 317 in step S706 in FIG. 13A corresponds to step S103 in FIG. 1. Then, steps S709 and S714 in FIG. 13B correspond to step S104.

From a certain point of view, the procedure according to the flowchart f1 in FIG. 1 is an example of the case in which no retry is performed in the procedure in FIGS. 13A and 13B (for example, the case in which retry is nullified by the retry flag RT_FLAG, or the case in which the initial value RT_CNT of the retry counter is 1). From another point of view, the procedure in FIGS. 13A and 13B is a procedure in which retry control is added between steps S103 and S104 in the flowchart F1 in FIG. 1.

According to the above-mentioned third embodiment, when memory allocation is requested in a heavy load state in which there is a strong likelihood that the memory allocation will fail, the trial of the memory allocation is postponed. Therefore, when memory allocation is practically performed, there is a possibility that the load of the entire computer 300 is reduced. That is, the likelihood for the success in memory allocation is enhanced by the postponement.

Therefore, according to the third embodiment, the problems of reduced efficiency, stall, hang, etc. are suppressed. Accordingly, a system test may be conducted efficiently in order.

Each of the above-mentioned second and third embodiments has the following features.

In the second embodiment, objective evidences indicating the load of the entire computer 300 are collected to determine whether or not memory allocation is tried. Concretely, as illustrated in FIGS. 5, 10A, and 10B, the value u_mem of the amount of memory usage and the value u_cpu of the amount of CPU usage are acquired as the objective evidences.

Then, to collect the evidences, the memory usage amount measurement unit 315 and the CPU load measurement unit 314 perform appropriate procedures. That is, the CPU 201 executes the command or the system call for realizing the memory usage amount measurement unit 315 and the CPU load measurement unit 314.

The time taken to perform the same procedure is longer when the load of the computer 300 is heavy than when the load of the computer 300 is low. Therefore, the run time (i.e., execution time) of the procedure for acquiring the value of the amount of memory usage and the value of the amount of CPU usage may be available as the objective evidence indicating the load of the computer 300.

In the second embodiment, as illustrated in FIGS. 5, 10A, and 10B, not only the value u_mem of the amount of memory usage and the value u_cpu of the amount of CPU usage, but also the time t_mem and t_cpu taken to acquire the respective values are used to determine whether or not memory allocation is to be tried. Furthermore, for the reason explained with reference to FIG. 5, as indicated in steps S503 and S505 in FIG. 10A, the run time is assigned a higher priority than the amount of usage in judging whether or not memory allocation is to be tried.

As described above, the second embodiment is based on the consideration that the run time of a certain type of procedure is available as an objective evidence indicating the load of the entire computer 300. The third embodiment is similar with the second embodiment in that it is based on the consideration. From a certain view point, the third embodiment is based on the consideration and further attempts to reduce the overhead in the memory acquisition procedure.

The overhead in the memory acquisition procedure according to the second embodiment is concretely the procedure by the memory usage amount measurement unit 315 and the CPU load measurement unit 314 in steps S501 and S502 in FIG. 5. On the other hand, as clearly known from the above-mentioned consideration and the regard of the runtime on a priority basis over the amount of usage, the value u_mem of the amount of memory usage and the value u_cpu of the amount of CPU usage are not always required as objective evidences of the load of the entire computer 300.

That is, if an appropriate procedure in which the run time reflects the load of the entire computer 300 has been practically performed, the run time of the procedure is adopted as an objective evidence of the load of the entire computer 300, thereby reducing the overhead. That is, the third embodiment seriously considers reducing the overhead by keeping balance between the correctness of the prediction as to whether or not the trial of memory allocation will succeed and the overhead.

In the third embodiment, the above-mentioned appropriate procedure is concretely the trial of memory allocation practically performed previously within a specified range prescribed by the duration VALID_DUR. An example of the case in which a request for memory allocation is repeated at intervals in a certain range is, for example, the following case.

As illustrated in FIG. 7, the test execution processing in step S205 is performed sequentially or concurrently on a plurality of devices to be tested. Then, although depending on the time taken to conduct each test, the memory acquisition processing in step S404 in FIG. 9 may be performed frequently at certain short intervals.

For convenience of explanation below, FIG. 7 illustrates step S205 to be executed only once on one device to be tested. However, the test control unit 305 may determine a plurality of test conditions on one device to be tested, and may invoke the procedure in FIG. 9 on each of the plurality of test conditions as in step S205. That is, the memory acquisition processing in step S404 may be performed on each of the plurality of test conditions.

The memory acquisition procedure of step S404 in FIG. 9 is concretely the procedure in FIGS. 13A and 13B in the third embodiment. Therefore, if the memory acquisition processing in step S404 is repeatedly performed at certain short intervals, the trial of memory allocation in step S706 in FIG. 13A is also repeated at certain short intervals.

Also in an arbitrary application other than the system test program, a request for memory allocation may be repeated at intervals in a certain range. Therefore, the memory acquisition procedure similar to that in FIGS. 13A and 13B according to the third embodiment may also be applied to an arbitrary application other than the system test program. Obviously, the memory acquisition procedure similar to that in FIGS. 10A and 10B according to the second embodiment may be applied to an arbitrary application other than the system test program.

The present invention is not limited to the first through third embodiments. Some variations are described above, but the embodiments above may also be varied from the following points of view. Each of the above-mentioned embodiments and the following variations may be arbitrarily combined unless mutually contradicted.

The first point of view of variations is related to a threshold. Some procedures according to the embodiments above include a comparison with a threshold (for example, steps S503 and S505 in FIG. 10A, and step S702 in FIG. 13A, etc.). The comparison with a threshold may be a procedure of judging whether or not a value to be compared exceeds a threshold, or a procedure of judging whether or not a value to be compared is not less than a threshold. Furthermore, various values in the management tables 501 and 601 may be appropriate and arbitrarily determined depending on the embodiments.

The second point of view of variations is related to the hardware configuration of a computer and a judgment condition.

FIG. 3 illustrates only one CPU 201, but the computer 200 may be a multiprocessor system including a plurality of CPUs. Furthermore, the RAM 202 in FIG. 3 may concretely be distributed on a plurality of DIMMs.

In addition, the above-mentioned embodiments may be applied to a non-uniform memory architecture (NUMA) system. A NUMA system includes a plurality of nodes connected to one another, and each node includes a CPU and RAM. Therefore, the NUMA system includes a plurality of CPUs and a plurality of memory modules.

When there are a plurality of CPUs as in the example above, the condition of a heavy CPU load in step S505 in FIG. 10A means a heavy load in all of the plurality of CPUs. When there are physically a plurality of memory modules, the condition of a large amount of memory usage in step S505 in FIG. 10A means a large amount of memory usage in all of the plurality of memory modules.

That is, the procedure in FIGS. 10A and 10B may be generalized as follows. In step S501, for each of one or more memory modules of the computer, the value u_mem of an amount of memory usage u_mem is acquired. In step S502, for each of one or more CPUs of the computer, the value u_cpu of an amount of CPU usage is acquired.

When the following condition 11-1 or 11-2 holds, the procedure in FIGS. 10A and 10B passes control from step S503 to step S505. On the other hand, when none of the conditions 11-1 and 11-2 hold, the procedure in FIGS. 10A and 10B passes control from step S503 to step S504.

(11-1) There is at least one memory module which has been able to acquire the value u_mem of the amount of memory usage in the time not more than the threshold TH_MEM.

(11-2) There is at least one CPU which has been able to acquire the value u_cpu of the amount of CPU usage in the time not more than the threshold TH_CPU.

When the following condition 12-1 or 12-2 holds, the procedure 10 passes control from step S505 to step S506. On the other hand, when none of the conditions 12-1 and 12-2 hold, the procedure in FIGS. 10A and 10B passes control from step S505 to step S504.

(12-1) There is at least one memory module whose value u_mem of the amount of memory usage is not more than the threshold HI_MEM.

(12-2) There is at least one CPU whose value u_cpu of the amount of CPU usage is not more than the threshold HI_CPU.

The reason why the procedure in FIGS. 10A and 10B is generalized as described above is described below. If there is one memory module having a physically sufficient area available, there is a strong likelihood that a new memory area is successfully allocated to the memory module. Furthermore, if there is one CPU of a low load, there is a strong likelihood that the CPU of the low load performs in order the procedure for releasing the memory area although there is a memory area being temporarily used by the OS for any purpose such as disk I/O etc. Therefore, considering the reason described above with reference to FIG. 5, the procedure in FIGS. 10A and 10B may be generalized.

When the procedure in FIGS. 10A and 10B is generalized as described above, the management table 501 and the constant data 502 in FIG. 6 are available. Similarly, when there are a plurality of CPUs or memory modules, the management table 601 and the constant data 602 in FIG. 11 are available.

For example, one management table 601 may be provided for the entire computer. In this case, when any of the plurality of CPUs performs the procedure in FIGS. 13A and 13B, the same management table 601 is updated in step S709 or S714. Otherwise, the management table 601 may be provided for each CPU.

The third point of view of variations is related to the level at which allocation control (that is, the judgment as to whether or not memory allocation is tried at a request for allocation) is implemented.

In the second and third embodiments, as clearly known from the memory acquisition unit 311 included in the layer of the application 301, the allocation control is implemented in the application level. However, as described above with reference to the first embodiment, the allocation control may be implemented in the library function or in the kernel of the OS. Otherwise, a library function or a hook function for hook of a system call may be defined, or allocation control may be implemented in a hook function.

Furthermore, it is obvious that the control according to the second or third embodiment may be implemented in an application other than a system test. Then, in the explanation of the second and third embodiments, the case in which a library function such as malloc( ) etc. is used is exemplified, but it is obvious that a system call is invoked directly without through a library function from an application.

Furthermore, depending on some embodiments, a library function other than the malloc( )(for example, calloc( ) valloc( ) etc.) may be used. Then, for memory allocation, a system call other than the exemplified mmap( )(for example, brk( ) may be used.

When allocation control is implemented in a library function or in a kernel, it is preferable that no retry or wait for a specified time is performed in the library function or in the kernel because the library function and the system call may be invoked from any application, and because the number of timed of retry or the wait time which are appropriate for an application may be inappropriate for another application. Therefore, when allocation control is implemented in the library function or the kernel, the following variation is preferable.

For example, a variable indicating a wait time, and a specific value indicating that it is recommended that memory allocation is requested again after waiting for a time set to a value indicating a wait time may be defined. The specific value is referred to below as a retry recommendation code for convenience of explanation below.

Then, step S105 may be deleted from the flowchart F1 in FIG. 1. Instead, when the judgment condition holds in step S102, the memory allocation control unit 106 may set the wait time in the variable above, set a retry recommendation code in the variable indicating an exit code, and terminate the procedure in flowchart F1. The flowchart F2 may be unchanged.

In the procedure in FIGS. 10A and 10B, steps S506 and S510 through S514 may be deleted. When it is judged in step S508 that allocation has failed, control may be passed from step S508 to step S515. In this case, in step S515, a retry recommendation code may be set as a variable indicating an exit code instead of the value indicating an abnormal termination. Then, for example, a value RT_WAIT of the retry wait time in FIG. 6 may be set as a variable indicating a wait time.

The procedure in FIGS. 13A and 13B may be modified as follows. That is, the memory acquisition unit 311 changed to be implemented in the library function or the kernel may operate as in the procedures 13-1 through 13-4 instead of waiting for a specified time in step S703. After operating according to the procedures 13-1 through 13-4, the memory acquisition unit 311 terminates the memory acquisition procedure in FIGS. 13A and 13B.

(13-1) The memory acquisition unit 311 sets an appropriate value (for example, a value RT_WAIT of the retry wait time) for a variable indicating a wait time.

(13-2) The memory acquisition unit 311 sets a retry recommendation code for the variable indicating an exit code.

(13-3) The memory acquisition unit 311 instructs the time measurement unit 316 to acquire the current time, and updates the management table 601 as in step S714.

(13-4) The memory acquisition unit 311 returns a NULL point to a caller of the memory acquisition procedure.

Furthermore, steps S704 and S710 through 713 may be deleted in the procedure in FIGS. 13A and 13B as with the transformation of the procedure in FIGS. 10A and 10B. If it is judged in step S708 that the allocation has failed, control may be passed from step S708 to step S714. In this case, in step S714, a retry recommendation code may be set as a variable indicating an exit code instead of the value indicating an abnormal termination. An appropriate value (for example, the value RT_WAIT of the retry wait time in FIG. 11) may be set as a variable indicating a wait time.

As described above, when allocation control is implemented in a library function or a kernel, the procedure in FIG. 1, FIGS. 10A-10B, or FIGS. 13A-13B may be appropriately modified.

When a retry recommendation code is set as a variable indicating an exit code, the application which has requested the memory allocation may perform appropriate retry control, and may perform an error procedure without requesting memory allocation again. Furthermore, the application may request memory allocation again after waiting a time different from the wait time set as a variable. That is, when allocation control is implemented in a library function or kernel, it is preferable that an application may freely control retry.

However, when the trial of the memory allocation performed previously is processed as a specific procedure as in the third embodiment, it is preferable that an application is prepared to make a wait time longer than the duration VALID_DUR in FIG. 11 if the retry control is performed because there is the possibility that the procedure transformed as described above as illustrated in FIGS. 13A and 13B may be invoked frequently in vain from an application in the duration VALID_DUR if the wait time determined by the application is not more than the duration VALID_DUR.

Then, memory allocation itself is not performed although a retry recommendation code is returned as in the procedures 13-1 through 13-4 for each invocation. That is, the procedure for judging that memory allocation is not executed consumes resources in vain.

To avoid the wasteful consumption of resources, for example, the following method is effective. That is, it is preferable to set await time longer than the duration VALID_DUR as a variable in the procedure 13-1. Then, it is also preferable that the application waits for a time longer than the time set as a variable before memory allocation is requested again.

That is, although it is preferable to implement an application with the freedom relating to the retry control, infinite freedom is not preferable from the view point of the improvement in efficiency of the entire computer. Concretely, it is preferable that an application is prepared so that every recommendation is satisfied without ignoring a wait time set for a variable (that is, a recommended wait time).

The fourth point of view is related to the management table 312 and the constant data 313. FIGS. 6 and 11 illustrate concrete examples of the management table 312 and the constant data 313 in table formats for convenience of explanation, but any other data format than the table format may be adopted.

Although four types of memory sizes are defined in the management table 601 in FIG. 11, the number Q (refer to FIG. 12) of memory sizes is not limited to four. Obviously, the upper limit and the lower limit indicating the range of each memory size may be arbitrary values depending on the embodiments.

As illustrated in FIGS. 6 and 11, in the second and third embodiments, the management table 312 includes not only a threshold, but also a reference value. However, there may be an embodiment in which a reference value is not included in the management table 312 because what is referenced later is not a reference value itself, but a threshold calculated from a reference value.

The management table 601 in FIG. 11 stores a previously measured time PREVj and a previous invocation time LTj for each memory size. However, a pair of the time taken to perform the trial and the time at which the memory acquisition and release unit 317 has been invoked for the trial may be stored for each memory size and for each trial of memory allocation of the latest β times with 1≦α≦β.

In this case, in step S701 in FIG. 13A, it is judged whether or not the number of times of valid invocation time in the latest β times of trials is not less than α times. That is, it is judged whether or not memory allocation has been tried not less than α times previously in the duration VALID_DUR from the present. Then, if the memory allocation has been tried not less than α times previously in the duration VALID_DUR from the present, control is passed to step S702. Otherwise, control is passed to step S704.

Furthermore, in step S702, it is judged which condition is satisfied, the condition 14-1 or 14-2, by the trials of not less than α times for which the invocation time is found to be valid.

(14-1) The time taken for the trial is set as an invalid value in the management table 601, or is longer than the threshold THj.

(14-2) The time taken for the trial is a valid value and is not more than the threshold THj.

If the number of times of trials corresponding to the condition 14-1 is not less than α, control is passed from step S702 to step S703. On the other hand, if the number of times of trials corresponding to the condition 14-1 is less than α, control is passed from step S702 to step S704.

As described above, the management table 601 may include the history of the latest β trials, and the procedure in FIGS. 13A and 13B may be appropriately modified according to the modification of the management table 601. The third embodiment is an example where α=β=1.

The fifth point of view of variations is related to whether or not the allocation control as illustrated in FIG. 1, FIGS. 10A-10B, or FIGS. 13A-13B is to be applied at all requests for memory allocation. By the allocation control as illustrated in FIG. 1, FIGS. 10A-10B, or FIGS. 13A-13B, the overhead of the memory allocation procedure increases. Therefore, from the viewpoint of overhead reduction, the target of allocation control as illustrated in FIG. 1, FIGS. 10A-10B, or FIGS. 13A-13B may be narrowed.

For example, when a request memory size is relatively small, there is a strong likelihood that the memory allocation will succeed although the load of the entire computer is relatively heavy. That is, when the requested memory size is relatively small, there is a small danger that a wasteful procedure in which there is a strong likelihood of failure consumes resources, and as a result, degrades the efficiency of the entire computer.

If the requested memory size is not more than the threshold TH, it is unnecessary to apply the allocation control as illustrated in FIG. 1, FIGS. 10A-10B, or FIGS. 13A-13B. That is, the requested memory size is not more than the threshold TH, the memory allocation may be unconditionally tried at the request of the memory allocation. The threshold TH may be, for example, the page size defined by the OS, and an appropriate value smaller than the page size. Then, the allocation control as illustrated in FIG. 1, FIGS. 10A-10B, or FIGS. 13A-13B may be performed only when the requested memory size exceeds the threshold TH.

The sixth point of view of variations is related to the acquisition of a reference value of the constant data 313.

The second and third embodiments are related to the system test. Therefore, the assumption that the load of the entire computer 300 at the time when the procedure in FIG. 8 or 12 is performed is high is a realistic assumption.

However, in the embodiment in which the allocation control according to the second and third embodiments is applied to a memory allocation request from any application, there are various cases as to when a computer is in a low load state. For example, when the OS is being booted, the load is relatively high. When a plurality of applications are simultaneously performed, the load is heavy.

Then, before the information acquisition unit 310 starts the execution of the procedure in FIG. 8 or 12, the CPU load measurement unit 314 may measure the load of the CPU, and the memory usage amount measurement unit 315 may measure the amount of usage of memory. If a result of the measurement that a computer indicates a low load, the information acquisition unit 310 starts the procedure in FIG. 8 or 12.

On the other hand, unless a computer indicates a low load, the information acquisition unit 310 waits for an appropriate time, then the CPU load measurement unit 314 measures the load of the CPU again, and the memory usage amount measurement unit 315 measures the amount of usage of memory again. If the above-mentioned procedures are repeated until it is known that the load is low, it is guaranteed that the procedure in FIG. 8 or 12 is performed when the load is low.

For example, the OS may control the measurement of the load and the start of the procedure by the information acquisition unit 310 so that the procedure in FIG. 8 or 12 is performed after the OS is completely booted, and when the execution of any application process is not started. Otherwise, when the allocation control is implemented at the application level, the above-mentioned measurement of a load and the start of the procedure by the information acquisition unit 310 may be controlled by an application.

The seventh point of view of variations is related to the execution order, omission, addition, and exchange of steps.

The order of steps illustrated in the flowcharts of FIGS. 1, 7 through 10B, 12, 13A, and 13B is exemplified, and the order of steps may be changed unless mutually contradicted. Furthermore, the procedures of exchangeable steps may be performed in parallel. For example, in FIG. 8, the procedures may be performed in the order of steps S304 through S306, S301 through S303, and S307 through S310.

In addition, step S504 in FIG. 10A may be replaced with the procedure of waiting for a specified time such as step S703 in FIG. 13A. In this case, after the lapse of the specified time, control is passed to step S506. On the other hand, step S703 in FIG. 13A may be modified to be the procedure similar to that in step S714 followed by terminating the entire memory acquisition procedure in FIGS. 13A and 13B.

Otherwise, some steps may be omitted. For example, in some embodiments, the judgment in step S510 in FIG. 10B may be omitted. In addition, the step exemplified relating to the third point of view of variations may be omitted.

On the other hand, a judgment similar to that in step S510 may be added to the procedure in FIGS. 13A and 13B. For example, a judgment similar to that in step S510 may be added between steps S708 and S710 in FIG. 13B.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A memory allocation control method executed by a processor in a computer including the processor and memory, the memory allocation control method comprising:
trying to allocate a block of the memory by the processor at a request for memory allocation, in a first case in which a result of a judgment on a probability of success or failure of the memory allocation based on a time taken for the processor to perform each of one or more specific procedures indicates that there is a high probability that the memory allocation succeeds; and
either trying to allocate the block of the memory by the processor with a delay with respect to the first case, or returning by the processor, without trying to allocate the block of the memory, a reply that the memory allocation has failed, in a second case in which the result of the judgment indicates that there is a high probability that the memory allocation fails.

2. The memory allocation control method according to claim 1, wherein:
the one or more specific procedures include at least one of:
a procedure of acquiring a value indicating an amount of usage or a ratio of usage of the memory after accepting the request, and
a procedure of acquiring a value indicating a load of the processor after accepting the request;
when a logical disjunction of a first condition and a logical conjunction of a second condition and a third condition is true, the result of the judgment indicates that there is a high probability that the memory allocation fails;
the first condition is that, for each individual specific procedure of the one or more specific procedures, a time taken for the processor to perform the individual specific procedure is longer than a first threshold which is determined depending on the individual specific procedure;
the second condition is that the amount of usage or the ratio of usage of the memory exceeds a second threshold; and
the third condition is that the load of the processor exceeds a third threshold.

3. The memory allocation control method according to claim 1, wherein:
the one or more specific procedures include a procedure which has been performed within a latest specified range of time and in which the processor has tried to allocate a block of the memory at a request to allocate the block of the memory; and
when a time taken in the latest specified range of time for the processor to reach a result of trying to allocate the block of the memory is longer than a threshold, the result of the judgment indicates that there is a high probability that the memory allocation fails.

4. The memory allocation control method according to claim 3, wherein a length of the delay in the second case is not less than a length of the latest specified range of time.

5. The memory allocation control method according to claim 1, wherein:
the one or more specific procedures include a first number of latest trials included in a plurality of trials of memory allocation performed previously by the processor;
when, for each trial of at least a second number of trials included in the first number of trials, a time taken for the processor to reach a result of the trial is longer than a threshold, the result of the judgment indicates that there is a high probability that the memory allocation fails.

6. The memory allocation control method according to claim 3, wherein the threshold is a value that depends on a memory size having been requested in a previous try at allocating the block of the memory.

7. The memory allocation control method according to claim 1, wherein in a case where the memory allocation fails as a result of trying to allocate the block of the memory, the memory allocation control method further comprises:
returning a reply that the memory allocation has failed, when a time taken to know that a try at allocating the block of the memory has resulted in failure is longer than a threshold;
trying to allocate the block of the memory again when the time is shorter than the threshold and a number of tries at allocating the block of the memory does not reach a specified number of times; and
returning a reply that the memory allocation has failed, when the memory allocation does not succeed even after the number of tries reaches the specified number of times.

8. The memory allocation control method according to claim 1, wherein in a case where the memory allocation fails as a result of trying to allocate the block of the memory, the memory allocation control method further comprises:
trying to allocate the block of the memory again unless a number of tries at allocating the block of the memory reaches a specified number of times; and
returning a reply that the memory allocation has failed, when the memory allocation does not succeed even after the number of tries reaches the specified number of times.

9. The memory allocation control method according to claim 1, wherein:
the processor executes an application program including a first code that invokes a library function or a system call for the memory allocation, and a second code that invokes the first code;
the request for the memory allocation is issued by the processor invoking the first code from the second code during execution of the second code;
the processor accepts the request for the memory allocation by starting execution of the invoked first code; and
the processor tries to allocate the block of the memory by invoking the library function or the system call during execution of the invoked first code.

10. The memory allocation control method according to claim 1, wherein:
the processor executes an application program that invokes a library function or a system call for the memory allocation;
the request for the memory allocation is issued by the processor invoking the library function or the system call during execution of the application program; and
the processor accepts the request for the memory allocation by starting execution of the invoked library function or system call.

11. A non-transitory computer-readable recording medium having stored therein a program for causing a processor included in a computer which also includes memory to execute processing comprising:
trying to allocate a block of the memory at a request for memory allocation, in a first case in which a result of a judgment on a probability of success or failure of the memory allocation based on a time taken for the processor to perform a specific procedure indicates that there is a high probability that the memory allocation succeeds; and
either trying to allocate the block of the memory with a delay with respect to the first case, or returning, without trying to allocate the block of the memory, a reply that the memory allocation has failed, in a second case in which the result of the judgment indicates that there is a high probability that the memory allocation fails.

12. An information processing device comprising:
memory; and
a processor configured to:
execute a first program using an area dynamically allocated on the memory;
perform a specific procedure according to a second program;
try to allocate a block of the memory at a request for memory allocation involved in executing the first program, in a first case in which a result of a judgment on a probability of success or failure of the memory allocation based on a time taken to perform the specific procedure indicates that there is a high probability that the memory allocation succeeds; and
either try to allocate the block of the memory with a delay with respect to the first case, or return a reply that the memory allocation has failed without trying to allocate the block of the memory, in a second case in which the result of the judgment indicates that there is a high probability that the memory allocation fails.
